(19) United States
(12) Patent Application Publication
(10) Pub. No.: US 2014/0097146 A1
(43) Pub. Date: Apr. 10, 2014

(54) CARBON NANOSTRUCTURE SEPARATION MEMBRANES AND SEPARATION PROCESSES USING SAME

(71) Applicant: APPLIED NANOSTRUCTURED SOLUTIONS, LLC, Baltimore, MD (US)

(72) Inventors: Tushar K. SHAH, Fulton, MD (US); Han LIU, Timonium, MD (US); Matthew R. LASZEWSKI, Halethorpe, MD (US); Daniel R. HOSKINS, Churchville, MD (US); Melissa L. JONES, Baltimore, MD (US); Saba SEYRAFI, North Bethesda, MD (US)

(73) Assignee: APPLIED NANOSTRUCTURED SOLUTIONS, LLC, Baltimore, MD (US)

(21) Appl. No.: 14/043,716

(22) Filed: Oct. 1, 2013

Related U.S. Application Data
(60) Provisional application No. 61/709,915, filed on Oct. 4, 2012.

(51) Int. Cl. B01D 69/08

(52) U.S. Cl. CPC B01D 69/081; Y10S 977/742; B82Y 99/00
USPC 210/791; 210/323.2; 210/767; 977/742; 977/902

(57) ABSTRACT

Carbon nanostructures can include a plurality of carbon nanotubes that are branched, crosslinked, and share common walls with one another, thereby defining a porous space having a tortuous path within the carbon nanostructures. The porous space can be used for sequestering a range of particulate sizes from various types of substances. Separation membranes can include a separation body having an effective pore size of about 1 micron or less and providing a tortuous path for passage of a substance therethrough. The separation body can include carbon nanostructures.

### CROSS-REFERENCE TO RELATED APPLICATIONS

This application claims the benefit of priority under 35 U.S.C. §119 from U.S. Provisional Patent Application 61/709,915, filed Oct. 4, 2012, which is incorporated herein by reference in its entirety.

### STATEMENT REGARDING FEDERALLY SPONSORED RESEARCH OR DEVELOPMENT

Not applicable.

### FIELD

The present disclosure generally relates to carbon nanostructures, and, more particularly, to separation membranes containing carbon nanostructures and separation processes using the same.

### BACKGROUND

Increasing worldwide needs for purified water have stimulated efforts to develop new water purification and desalination strategies. Membrane filtration technologies represent a major focus of current water purification techniques. As used herein, the term “membrane” refers to a thin material having a plurality of pores of a specific size range extending therethrough. Membranes can function through “size exclusion” by allowing substances smaller than the pore size to pass through the membrane, while larger substances (e.g., particulates) are sequestered. Membranes can also function, at least in part, through “affinity” by selectively interacting with and retaining certain substances over others. Before further discussing membrane filtration techniques, other water purification strategies will be described in brief hereinafter. It should be noted that liquids other than water and even gases can undergo membrane separation in a like manner.

Purification techniques based upon phase change processes represent about 40% of the worldwide desalination capacity. These techniques employ distillation or evaporation of the water, followed by its condensation in a purified state. Phase change processes are highly prone to scale formation, have a limited operating temperature range, and sometimes provide only marginal separation performance. Moreover, because of water's high heat of vaporization, energy input needs for these processes are very high.

Capacitive deionization can be used to cause ions in water to migrate and adsorb on electrode surfaces, thereby leaving purified water. Energy input demands for these types of processes are typically high, and inadequate electrode surface area can be a limiting factor in their success. Moreover, non-ionic substances are not separable by these techniques. Electrodialysis techniques, in which cations and anions migrate in opposite directions across a membrane, can also be utilized in a somewhat related manner. Again, energy input needs remain high with these techniques.

Reverse osmosis techniques are also widely used for water purification. In reverse osmosis, high pressure is used to force water through a semi-permeable membrane, while restricting the flow of ions through the membrane. In order to be effective, the applied pressure must exceed the osmotic pressure of the source water in order to drive the water from an area of higher ionic concentration to an area of lower ionic concentration. The semi-permeable membranes used in reverse osmosis processes are commonly polymeric membranes and can be prone to fouling and scaling, thereby impacting the through-membrane flux. Due to their chemical makeup, it can often be problematic to effectively remove scale and other fouling materials from a reverse osmosis membrane. These issues can also be problematic for other types of size exclusion membranes as well.

Carbon nanotubes (CNTs) have been proposed for use in a number of applications that can take advantage of their unique combination of chemical, mechanical, electrical, and thermal properties. Various difficulties have been widely recognized in many applications when working with individual carbon nanotubes. These difficulties can include the propensity for individual carbon nanotubes to group into bundles or ropes, as known in the art. Although there are various techniques available for de-bundling carbon nanotubes into well-separated, individual members (e.g., including sonication in the presence of a surfactant), many of these techniques can detrimentally impact the desirable property enhancements that pristine carbon nanotubes are able to provide. In addition to the foregoing, widespread concerns have been raised regarding the environmental health and safety profile of individual carbon nanotubes due to their small size. Furthermore, the cost of producing individual carbon nanotubes may be prohibitive for the commercial viability of these entities in many instances.

One carbon nanotube form that has often been proposed for use in certain applications is a freestanding, thin layer of carbon nanotubes, commonly referred to in the art as a carbon nanotube mat or a “buckypaper.” Carbon nanotube mats are often prepared by filtering a fluid dispersion of individualized carbon nanotubes onto a suitable collection medium. After filtration is complete, the mat can be peeled away from the collection medium as a freestanding carbon nanotube layer. However, carbon nanotube mats formed in this manner often have a low bulk density that can pose issues for many downstream applications. Surfactants used in producing individualized carbon nanotubes can often be difficult to completely eliminate from the carbon nanotube mat, thereby further eroding the beneficial properties of the carbon nanotubes. Further, there can be some shedding of individual carbon nanotubes from carbon nanotube mats, raising both structural integrity and environmental health and safety issues with these entities.

There has been some interest in the use of carbon nanotube mats as a filtration medium. Despite the many favorable properties of carbon nanotubes, conventional carbon nanotube mats can be of limited value for filtration due to the issues noted above and others. Present techniques for forming carbon nanotube mats offer limited opportunities to alter the pore size of the mats in order to sequester particulate materials of a desired size range. Moreover, due to the non-bonded, highly agglomerated nature of the carbon nanotubes in conventional carbon nanotube mats, the internal pore structure of the mats can be transient and highly irregular in size, thereby offering only limited value and reliability as a filter medium. Further, in addition to the environmental health and safety concerns noted above, the shedding of individual carbon nanotubes from a mat can compromise the integrity of a fluid phase being purified with the mat, possibly rendering the fluid phase unsuitable for its intended application.

In view of the foregoing, production of carbon nanotubes in a form that renders them more amenable for use in membrane filtration techniques would be highly desirable. The present disclosure satisfies the foregoing needs and provides related advantages as well.

### SUMMARY

In some embodiments, the present disclosure provides separation membranes having a separation body with an effective pore size of about 1 micron or less and providing a tortuous path for passage of a substance therethrough, in which the separation body includes carbon nanostructures. Each carbon nanostructure contains a plurality of carbon nanotubes that are branched, crosslinked, and share common walls with one another.

In some embodiments, the present disclosure provides separation systems having at least one separation membrane containing a separation body. The separation body has an effective pore size of about 1 micron or less and provides a tortuous path for passage of a substance therethrough. The separation body includes carbon nanostructures. Each carbon nanostructure contains a plurality of carbon nanotubes that are branched, crosslinked, and share common walls with one another.

In some embodiments, the present disclosure provides methods that include providing at least one separation membrane containing a separation body having an effective pore size of about 1 micron or less and providing a tortuous path for passage of a substance therethrough, passing a fluid phase containing particulate matter through the at least one separation membrane, sequestering at least a portion of the particulate matter in at least a portion of the at least one separation membrane, and eluting the fluid phase from the at least one separation membrane. The eluted fluid phase has a decreased quantity of particulate matter therein. The separation body includes carbon nanostructures. Each carbon nanostructure contains a plurality of carbon nanotubes that are branched, crosslinked, and share common walls with one another.

The foregoing has outlined rather broadly the features of the present disclosure in order that the detailed description that follows can be better understood. Additional features and advantages of the disclosure will be described hereinafter, which form the subject of the claims.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIGS. 1A-1C show illustrative depictions of carbon nanotubes 1-3 that are branched, crosslinked, and share common walls, respectively;

FIG. 2 shows an illustrative depiction of a carbon nanostructure flake material after isolation of the carbon nanostructure from a growth substrate;

FIG. 3 shows a SEM image of an illustrative carbon nanostructure obtained as a flake material;

FIG. 4 shows a schematic of an illustrative separation membrane having carbon nanostructures that progressively decrease in effective pore size in the direction of intended fluid flow;

FIG. 5 shows a schematic of an illustrative separation stream in which the separation regions of FIG. 4 are spaced apart from one another as multiple separation bodies in series, each with a progressively decreasing effective pore size in the direction of intended fluid flow;

FIG. 6 shows a block diagram schematic of a separation system having a separation body with multiple carbon nanostructure layers that are in direct contact with one another;

FIG. 7 shows a block diagram schematic of a separation system having multiple separation membranes that are spaced apart from one another and contain carbon nanostructures;

FIG. 8 shows a flow diagram of an illustrative carbon nanostructure growth process which employs an exemplary glass or ceramic growth substrate;

FIG. 9 shows an illustrative schematic of a transition metal nanoparticle coated with an anti-adhesive layer;

FIG. 10 shows a flow diagram of an illustrative process for isolating a carbon nanostructure from a growth substrate;

FIG. 11 shows an illustrative schematic further elaborating on the process demonstrated in FIG. 10;

FIG. 12 shows an illustrative schematic demonstrating how mechanical shearing can be used to remove a carbon nanostructure and a transition metal nanoparticle catalyst from a growth substrate; and

FIG. 13 shows an illustrative schematic demonstrating a carbon nanostructure removal process in which a carbon nanostructure can be isolated from a growth substrate absent a transition metal nanoparticle catalyst.

### DETAILED DESCRIPTION

The present disclosure is directed, in part, to separation membranes containing carbon nanostructures. The present disclosure is also directed, in part, to separation systems containing at least one separation membrane containing carbon nanostructures. The present disclosure is also directed, in part, to separation methods using carbon nanostructures.

As discussed above, separation membranes used in conventional purification processes can be susceptible to corruption from a number of sources, including scaling and plugging from the very substances that they are designed to filter. In addition, conventional separation membranes can sometimes be susceptible to fouling by biological substances. All of these occurrences are nevertheless expected events during separation processes, and various actions can be taken to remediate the unwanted condition and at least partially restore the separation membrane to its original condition. In some instances, the through-membrane flux can be increased simply by backflushing the membrane in the opposite direction of normal fluid flow to remove sequestered particulates that impede the fluid flow. However, unless a swing bed membrane configuration is employed, backflushing of the membrane in the foregoing manner can result in process downtime while regeneration of the membrane occurs. Chemical treatments can also be used to remove particulates impeding normal fluid flow, but a number of conventional membrane materials can be susceptible to degradation by many of the agents and conditions used to remove the most common types of scale and plugging particulates. As a further difficulty, many conventional separation membranes are limited in the degree of pore size control that they are able to offer, at least without relying on expensive membrane production techniques, such as lithography.

As further discussed above, there has been some interest in carbon nanotube mats as a separation medium, but they can present a number of difficulties in this regard, especially for high performance applications. The issues can include limited pore size control, lack of a robust pore structure, and potential environmental health and safety issues due to shedding of carbon nanotubes. In addition, the shedding of carbon nanotubes can increase the particulate count of a fluid phase, rather than decreasing it as intended.

In order to provide carbon nanotubes in a form that addresses many of their handling and deployment issues in various applications, at least some of the present inventors previously developed techniques to prepare carbon nanostructures infused to various fiber materials through direct growth of the carbon nanostructures thereon. As used herein, the term “carbon nanostructure” refers to a plurality of carbon nanotubes that can exist as a polymeric structure by being interdigitated, branched, crosslinked, and/or sharing common walls with one another. Carbon nanostructures can be considered to have a carbon nanotube as a base monomer unit of their polymeric structure. By growing carbon nanostructures on a substrate (e.g., a fiber material) under carbon nanostructure growth conditions, at least a portion of the carbon nanotubes in the carbon nanostructures can be aligned substantially parallel to one another, much like the parallel carbon nanotube alignment seen in conventional carbon nanotube forests. The substantially parallel alignment can be maintained once the carbon nanostructures are removed from the growth substrate, as discussed below. Infusing carbon nanostructures to a fiber material by direct growth can allow the beneficial properties of the carbon nanotubes (i.e., any combination of chemical, mechanical, electrical, and thermal properties) to be conveyed to the fiber material and/or a matrix material in which the carbon nanostructure-infused fiber material is disposed. Moreover, by infusing carbon nanostructures to a fiber material, many of the handling difficulties and potential environmental health and safety concerns of individual carbon nanotubes can be avoided, since the risk of shedding the strongly bound carbon nanotubes is minimal.

Conventional carbon nanotube growth processes have most often focused on the production of high purity carbon nanotubes containing a minimum number of defects. While such conventional carbon nanotube growth processes typically take several minutes or more to produce carbon nanotubes having micron-scale lengths, the carbon nanostructure growth processes described herein employ a nominal carbon nanotube growth rate on the order of several microns per second in a continuous, in situ growth process on a growth substrate. As a result, the carbon nanotubes within the carbon nanostructures are more defective compared to those in a conventional carbon nanotube forest or unbound carbon nanotubes. That is, the resultant carbon nanostructures contain carbon nanotubes that are highly entangled, branched, crosslinked, and share common walls, thereby forming a macrostructure that is defined by more than just the structural features of carbon nanotubes themselves. As a result, the carbon nanostructures have a highly porous macrostructure that is defined the carbon nanotubes and their connections to one another. Unlike carbon nanotube mats, the porous macrostructure in carbon nanostructures is robustly maintained by the covalent connections between the carbon nanotubes.

In most cases, prior preparations of carbon nanostructure-infused fiber materials have resulted in very robust adherence of the carbon nanostructures to the fiber material, such that the carbon nanostructures are not easily removed from the fiber material, at least without significantly damaging the carbon nanotubes themselves. Although carbon nanostructure-infused fiber materials can be used satisfactorily as a replacement for individual carbon nanotubes in many applications, at least some of the present inventors recognized that in some instances it might be more desirable to utilize carbon nanostructures that are free of the fiber material upon which they are grown, while retaining the ready carbon nanotube handling attributes afforded by having the carbon nanostructures infused to the fiber material. Techniques for affecting removal of carbon nanostructures from a growth substrate are set forth hereinbelow and are described in more detail in commonly owned U.S. patent application Ser. No. 14/035,856 entitled “Carbon Nanostructures and Methods for Making the Same,” filed on Sep. 24, 2013 and incorporated herein by reference in its entirety.

In regard to separation and purification processes, the present inventors recognized that carbon nanostructures removed from their growth substrates could be readily utilized to form a separation membrane with a highly tailored effective pore size, as discussed in more detail below. Although carbon nanotube-infused fiber materials can be used in separation processes in alternative embodiments of the present disclosure, it is believed that “freestanding” carbon nanostructures can provide much more flexibility in tuning the properties of separation membranes formed therefrom, particularly their effective pore size. As used herein, the term “effective pore size” refers to the largest size particulate that will pass through a carbon nanostructure layer or layers of a given dimension. Even though some of the individual channels in the carbon nanostructures can be larger in dimension than the particulates being retained, they may not extend through the entirety of the carbon nanostructure and a sufficient number of narrower channels interconnecting and extending from the larger channels can result in particulate retention. Substantially straight channels, as found in many conventional separation membranes, can result in an effective pore size that is essentially the same as that of the channel size. Carbon nanostructures, in contrast, present a tortuous path for the passage of substances due to their complex macrostructure. As used herein, the term “tortuous path” refers to a randomly directed channel that may or may not be uniform in size throughout its entirety. Even if particulates are small enough to pass through the entirety of a tortuous path, the twists and turns of the tortuous path can make it much more difficult for the particulates to pass through the entirety of the carbon nanostructure, since they must negotiate the complex flow pathway. Thus, the rate of passage for all particulate sizes is slowed in a tortuous path, and some particulates that are smaller in size than even the smallest channel may not pass through the carbon nanostructure. Since the tortuous path within a carbon nanostructure is random and need not necessarily be uniform in size, a particulate can sometimes negotiate only a portion of the tortuous path before becoming trapped in a narrower downstream channel. Because carbon nanostructures have such a high internal surface area and present such a complex macrostructure, they can sequester a significant quantity of particulates before undergoing a reduction in fluid flux.

The effective pore size of carbon nanostructures can be readily tailored in a number of ways so that they can be used to retain and separate particulates of a desired size. By increasing the through-plane thickness of a carbon nanostructure, the effective pore size can be decreased, simply because the increased thickness can make it more difficult for a particulate of a given size to negotiate the tortuous path therein. Increasing the through-plane thickness of carbon nanostructures can be accomplished simply by stacking multiple layers of carbon nanostructures upon one another. For example, in some embodiments, carbon nanostructure mats made from carbon nanostructure flake materials, described further hereinbelow, can be stacked upon one another to increase the through-plane thickness and decrease the effective pore size of a separation membrane formed therefrom. The effective pore size of the carbon nanostructures can also be adjusted by intentionally plugging the channels within the carbon nanostructures with particulates having a certain size, such that only smaller particulates remain capable of passing through the carbon nanostructure.

Moreover, the effective pore sizes of the carbon nanostructures in a separation membrane can be progressively decreased in the direction of intended fluid flow so that upstream portions of the separation membrane sequester larger particulates, thereby protecting downstream portions with a smaller effective pore size from plugging. That is, different sizes of particulates can be retained at successive locations within the separation membranes. A progressive decrease in the effective pore size can be accomplished with variously configured carbon nanostructure layers all grouped together in a monolithic structure, or the carbon nanostructure layers can be spaced apart, such that they each carbon nanostructure layer or grouping thereof constitutes a distinguishable, independent separation membrane. Spacing the carbon nanostructures apart as independent separation membranes may be desirable from a maintenance standpoint, since any separation membranes that become irreversibly plugged in the course of operation can simply be replaced without disturbing other system components. For example, a separation membrane formed from carbon nanostructures and configured for removing large particulates may be relatively easy to fabricate and may be used to conduct an initial separation of a fluid phase, possibly even as a sacrificial filter. Carbon nanostructures with a narrower and more tailored effective pore size range, in contrast, may be somewhat more difficult to fabricate and configure. Thus, it can be desirable to protect the carbon nanostructures configured for retaining smaller particulates from plugging. Although any carbon nanostructure separation membrane can be used sacrificially in the embodiments described herein, it is believed to be desirable in most cases to regenerate the filter membranes to avoid having to configure the effective pore size of a replacement separation membrane.

In addition to the opportunity to readily tune their effective pore sizes, carbon nanostructures offer further advantages for separation processes. Carbon nanostructures can be readily functionalized by reactions similar to those used for functionalizing carbon nanotubes, thereby allowing the carbon nanostructures to be covalently modified to produce a desired set of properties for conducting a particular separation process. For example, carbon nanostructures can be functionalized with polar groups to increase wetting of the carbon nanostructures with polar liquids, which may increase filterability. Functionalization can also allow carbon nanostructures to be covalently attached to various groups that have affinity for certain types of particulates. For example, carbon nanostructures that are covalently functionalized with a metal-binding agent can be used to affect sequestration of metals within the carbon nanostructure. Various reactions for functionalizing carbon nanotubes will be familiar to one having ordinary skill in the art and may be applicable to the functionalization of carbon nanostructures.

Another advantage of carbon nanostructures for membrane separation processes is their chemical stability, which can be much greater than that of conventional separation membranes. Accordingly, carbon nanostructure separation membranes can tolerate much more rigorous chemical treatments to remove particulates during the course of regeneration than can conventional filter membranes. In addition, carbon nanostructures are fairly resistant to biofouling, thereby lessening the occurrence of another source of process downtime that commonly is present with conventional separation membranes. Moreover, for any biofouling that does occur, carbon nanostructures can readily tolerate the chemical and biocidal treatments commonly used for bioremediation of surfaces, unlike some conventional separation membranes. Biofouling can also be removed by applying a potential to a separation membrane. Not only are carbon nanostructures tolerant to application of a potential, but they are electrically conductive in most cases, thereby facilitating its application. Conventional membrane materials, in contrast, are not electrically conductive and are much more susceptible to breakdown in the presence of an applied potential. In addition, carbon nanostructures can be covalently functionalized with antimicrobial or other biocidal agents to further limit the occurrence of biofouling.

The ability to apply a potential to carbon nanostructures can have further advantages when conducting separation processes. By applying either a positive or negative potential to carbon nanostructures, ions of the same charge can be repelled from entry to the carbon nanostructures, and ions of the opposite charge can be attracted to enter the carbon nanostructures and undergo sequestration. Thus, carbon nanostructures can be used to carry out selective separation processes. Moreover, carbon nanostructures can also be functionalized with functional groups having either a positive or negative charge to facilitate charge-based separation processes without applying a potential to the carbon nanostructures.

Carbon nanostructures also have a very high contact angle with water (>100 degrees), which can be favorable for conducting water purification processes. Particularly in reverse osmosis separations, the high contact angle of carbon nanostructures can provide distinct advantages in separating dissolved molecules and salts from water.

As alluded to above, carbon nanostructures are a much more stable structural entity than are agglomerated individual carbon nanotubes. Even when liberated from their growth substrates, the desirable features of carbon nanostructures can be maintained, such as their robust internal porosity and minimal propensity to shed carbon nanotubes, which can present issues from both an environmental health and safety standpoint and a quality control standpoint during separation processes. Further advantages of carbon nanostructures in this regard are discussed hereinafter.

Carbon nanostructures can be removed from their growth substrates as a low density carbon nanostructure flake or like particulate material. The features of branching, crosslinking, and sharing common walls among the carbon nanotubes can be preserved when the carbon nanostructures are removed from their growth substrates, such that the carbon nanotubes are in a pre-exfoliated (i.e., at least partially separated) state within the carbon nanostructure flake, which maintains a high degree of internal porosity. Due to their robust porosity, a fluid dispersion of carbon nanostructures can remain much more filterable than can a fluid dispersion of individual carbon nanotubes, thereby allowing carbon nanostructure mats to be prepared with significantly greater through-plane thicknesses than can carbon nanotube mats made in a comparable manner. The porosity of carbon nanostructure mats also facilitates their use as a separation membrane, as in the embodiments described herein. In addition, whereas conventional carbon nanotube mats prepared by filtration of a fluid dispersion most often contain only randomly oriented carbon nanotubes, the as-produced parallel carbon nanotube alignment in carbon nanostructures can be locally maintained when multiple carbon nanostructures become agglomerated with one another to form a carbon nanostructure mat.

Another advantage of carbon nanostructures over individual carbon nanotubes is that carbon nanostructures are believed to provide a better environmental health and safety profile compared to individual carbon nanotubes. Because a carbon nanostructure is macroscopic in size relative to an individual carbon nanotube, it is believed a freestanding carbon nanostructure can present fewer toxicity concerns and rival the environmental health and safety profile of carbon nanotubes infused to a fiber material. Without being bound by any theory, it is believed that the improved environmental health and safety profile of carbon nanostructures can result, at least in part, from the size and structural integrity of the carbon nanostructure itself. That is, the bonding interactions between carbon nanotubes in a carbon nanostructure can provide a robust material that does not readily separate into harmful submicron particulates, such as those associated with respiration toxicity. Moreover, as discussed above, the substantial lack of shedding of carbon nanotubes from carbon nanostructures can also facilitate their use in separation processes.

As a further advantage of carbon nanostructures relative to individual carbon nanotubes, it is believed that carbon nanostructures can be produced much more rapidly and inexpensively and with a higher carbon feedstock conversion percentage than can related carbon nanotube production techniques. This feature can provide better process economics, especially for large scale operations. Some of the best performing carbon nanotube growth processes to date have exhibited a carbon conversion efficiency of at most about 60%. In contrast, carbon nanostructures can be produced on a fiber material with carbon conversion efficiencies of greater than about 85%. Thus, carbon nanostructures provide a more efficient use of carbon feedstock material and associated lower production costs.

In various embodiments, separation membranes containing carbon nanostructures are described herein. In some or other embodiments, separation systems containing at least one separation membrane containing carbon nanostructures are similarly described herein.

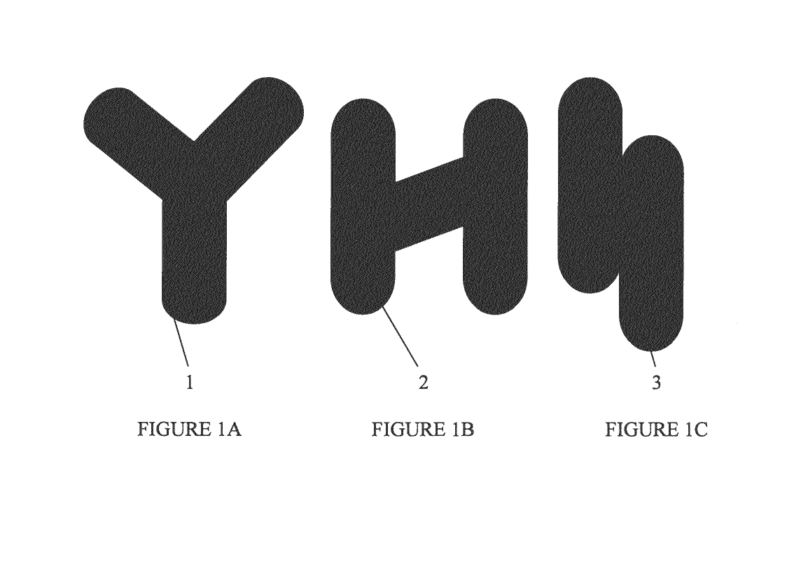

In some embodiments, separation membranes can include a separation body having an effective pore size of about 1 micron or less and providing a tortuous path for passage of a substance therethrough. The separation body includes carbon nanostructures, where each carbon nanostructure includes a plurality of carbon nanotubes that are branched, crosslinked, and share common walls with one another. It is to be recognized that every carbon nanotube in the plurality of carbon nanotubes does not necessarily have the foregoing structural features of branching, crosslinking, and sharing common walls. Rather, the plurality of carbon nanotubes as a whole can possess one or more of these structural features. That is, in some embodiments, at least a portion of the carbon nanotubes are branched, at least a portion of the carbon nanotubes are crosslinked, and at least a portion of the carbon nanotubes share common walls. FIGS. 1A-1C show illustrative depictions of carbon nanotubes 1-3 that are branched, crosslinked, and share common walls, respectively. The carbon nanotubes in the carbon nanostructures can be formed with branching, crosslinking, and sharing common walls with one another during formation of the carbon nanostructures on a growth substrate. Moreover, during formation of the carbon nanostructures on a growth substrate, the carbon nanotubes can be formed such that they are substantially parallel to one another in the carbon nanostructures. The carbon nanostructures can be considered to be a polymer having a carbon nanotube as a base monomer unit that is in parallel alignment with at least some other carbon nanotubes. Accordingly, in some embodiments, at least a portion of the carbon nanotubes in each carbon nanostructure are aligned substantially parallel to one another.

It is to be further understood that every carbon nanotube in the carbon nanostructures need not necessarily be branched, crosslinked, or share common walls with other carbon nanotubes. For example, in some embodiments, at least a portion of the carbon nanotubes in the carbon nanostructures can be interdigitated with one another and/or with branched, crosslinked, or common wall carbon nanotubes in the remainder of the carbon nanostructure.

The carbon nanostructures can have a web-like morphology that results in the carbon nanostructures having a low bulk density. As-produced carbon nanostructures can have an initial bulk density ranging between about 0.003 g/cm³ and about 0.015 g/cm³. Further consolidation and/or coating to produce a carbon nanostructure flake material or like morphology can raise the bulk density to a range between about 0.1 g/cm³ to about 0.15 g/cm³. In some embodiments, optional further modification of the carbon nanostructures can be conducted to further alter the bulk density and/or another property of the carbon nanostructures. Coating the carbon nanotubes and/or infiltrating the interior of the carbon nanostructures can further tailor the properties of the carbon nanostructures for use in various applications. Moreover, in some embodiments, forming a coating on the carbon nanotubes can desirably facilitate handling of the carbon nanostructures. Further compaction can also raise the bulk density to an upper limit of about 1 g/cm³, with chemical modifications to the carbon nanostructures raising the bulk density to an upper limit of about 1.2 g/cm³. With regard to separation membranes, infiltrating the interior of the carbon nanostructures (e.g., with particulates of a certain size) can affect the effective pore size by blocking flow pathways below a certain size within the carbon nanostructures.

As-produced carbon nanostructures can be agglomerated and densified into a carbon nanostructure layer to produce an analog of a carbon nanotube mat. A more detailed description of carbon nanostructure mats and like carbon nanostructure layers is provided in commonly owned U.S. patent application Ser. No. 14/037,264 entitled “Carbon Nanostructure Layers and Methods for Making the Same,” filed on Sep. 25, 2013 and incorporated herein by reference in its entirety. In some embodiments, agglomerated carbon nanostructure layers can be used in the embodiments described herein. In other embodiments, carbon nanostructures can be layered without the carbon nanostructures becoming agglomerated with one another and undergoing densification. Upon agglomerating a plurality of carbon nanostructures to form a carbon nanostructure layer, an increase in bulk density over that of the initial bulk density of the as-produced carbon nanostructures can be realized. In various embodiments, the carbon nanostructure layer can have a bulk density greater than about 0.4 g/cm³. In other embodiments, the carbon nanostructure layer can have a bulk density greater than about 0.6 g/cm³, or greater than about 0.8 g/cm³, or greater than about 1.0 g/cm³. It is believed that the upper limit in bulk density of the carbon nanostructure layer is determined by the density of an individual carbon nanotube (i.e., about 2 g/cm³). Accordingly, in various embodiments, the carbon nanostructure layer can have a bulk density ranging between about 0.4 g/cm³ and about 2.0 g/cm³. In more specific embodiments, the carbon nanostructure layer can have a bulk density ranging between about 0.8 g/cm³ and about 1.5 g/cm³, or between about 1.0 g/cm³ and about 1.5 g/cm³, or between about 1.0 g/cm³ and about 2.0 g/cm³. Based on the chosen application in which the carbon nanostructure layer is ultimately utilized, one of ordinary skill in the art will be able to choose an appropriate bulk density needed to take advantage of the desirable properties of the carbon nanotubes in the carbon nanostructure layer.

In some embodiments of the separation membranes described herein, the carbon nanostructures can be free of a growth substrate adhered to the carbon nanostructure. That is, in some embodiments, the separation membranes can be formed from carbon nanostructures that have been removed from their growth substrate. In other embodiments, carbon nanostructures that are adhered to a fiber material or like growth substrate can be used to make supported separation membranes. Although supported separation membranes are contemplated in some embodiments of the present disclosure, free carbon nanostructures are believed to be more desirable for separation processes, since the effective pore size of the carbon nanostructures can be readily altered by stacking or layering the carbon nanostructures upon one another to increase the pathlength of a substance passing therethrough.

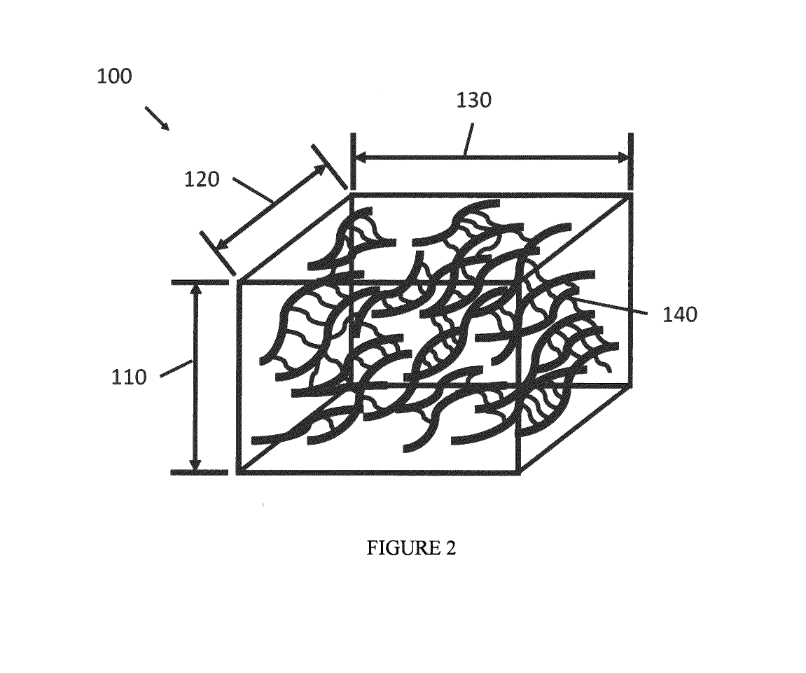

In some embodiments, the carbon nanostructures can be in the form of a flake material after being removed from the growth substrate upon which the carbon nanostructures are initially formed. As used herein, the term “flake material” refers to a discrete particle having finite dimensions. FIG. 2 shows an illustrative depiction of a carbon nanostructure flake material after isolation of the carbon nanostructure from a growth substrate. Flake structure 100 can have first dimension 110 that is in a range from about 1 nm to about 35 μm thick, particularly about 1 nm to about 500 nm thick, including any value in between and any fraction thereof. Flake structure 100 can have second dimension 120 that is in a range from about 1 micron to about 750 microns tall, including any value in between and any fraction thereof. Flake structure 100 can have third dimension 130 that is only limited in size based on the length of the growth substrate upon which the carbon nanostructures are initially formed. For example, in some embodiments, the process for growing carbon nanostructures on a growth substrate can take place on a tow or roving of a fiber-based material of spoolable dimensions. The carbon nanostructure growth process can be continuous, and the carbon nanostructures can extend the entire length of a spool of fiber. Thus, in some embodiments, third dimension 130 can be in a range from about 1 m to about 10,000 m wide. Again, third dimension 130 can be very long because it represents the dimension that runs along the axis of the growth substrate upon which the carbon nanostructures are formed. Third dimension 130 can also be decreased to any desired length less than 1 m. For example, in some embodiments, third dimension 130 can be on the order of about 1 micron to about 10 microns, or about 10 microns to about 100 microns, or about 100 microns to about 500 microns, or about 500 microns to about 1 cm, or about 1 cm to about 100 cm, or about 100 cm to about 500 cm, up to any desired length, including any amount between the recited ranges and any fractions thereof. Since the growth substrates upon which the carbon nanostructures are formed can be quite large, exceptionally high molecular weight carbon nanostructures can be produced by forming the polymer-like morphology of the carbon nanostructures as a continuous layer on a suitable growth substrate.

Referring still to FIG. 2, flake structure 100 can include a webbed network of carbon nanotubes 140 in the form of a carbon nanotube polymer (i.e., a “carbon nanopolymer”) having a molecular weight in a range from about 15,000 g/mol to about 150,000 g/mol, including all values in between and any fraction thereof. In some embodiments, the upper end of the molecular weight range can be even higher, including about 200,000 g/mol, about 500,000 g/mol, or about 1,000,000 g/mol. The higher molecular weights can be associated with carbon nanostructures that are dimensionally long. In various embodiments, the molecular weight can also be a function of the predominant carbon nanotube diameter and number of carbon nanotube walls present within the carbon nanostructures. In some embodiments, the carbon nanostructures can have a crosslinking density ranging between about 2 mol/cm³ to about 80 mol/cm³. The crosslinking density can be a function of the carbon nanostructure growth density on the surface of the growth substrate as well as the carbon nanostructure growth conditions.

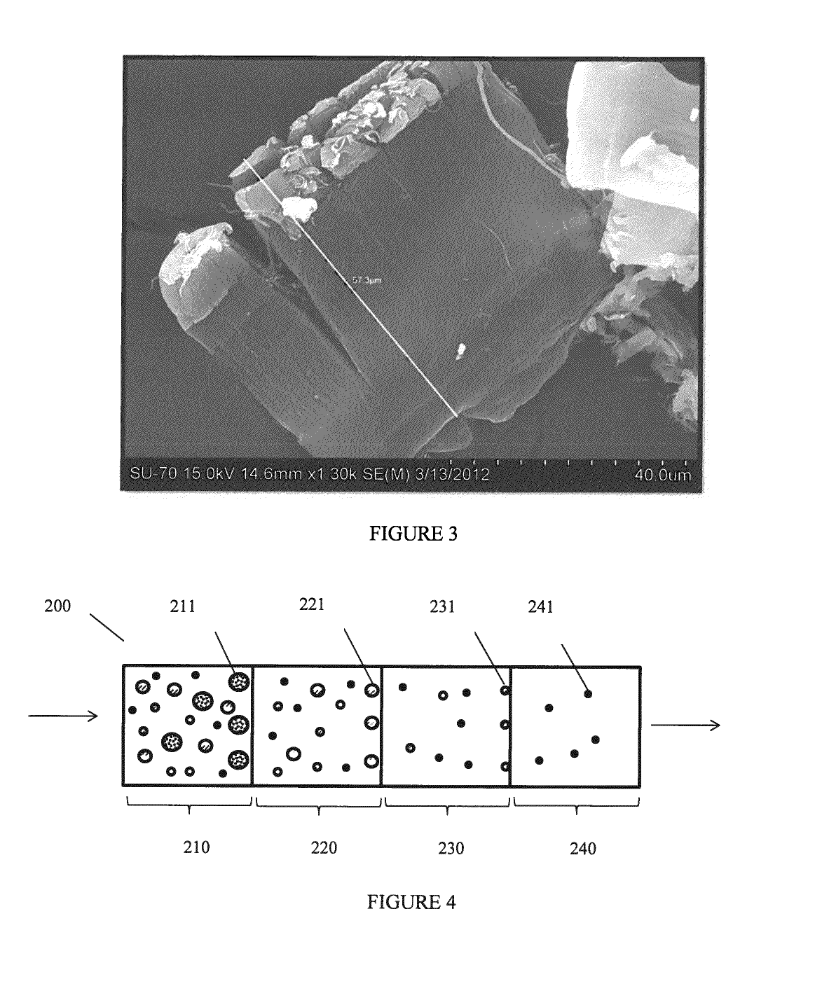

FIG. 3 shows a SEM image of an illustrative carbon nanostructure obtained as a flake material. The carbon nanostructure shown in FIG. 3 exists as a three dimensional microstructure due to the entanglement and crosslinking of its highly aligned carbon nanotubes. The aligned morphology is reflective of the formation of the carbon nanotubes on a growth substrate under rapid carbon nanotube growth conditions (e.g., several microns per second, such as about 2 microns per second to about 10 microns per second), thereby inducing substantially perpendicular carbon nanotube growth from the growth substrate. Without being bound by any theory or mechanism, it is believed that the rapid rate of carbon nanotube growth on the growth substrate can contribute, at least in part, to the complex structural morphology of the carbon nanostructures. In addition, the as-produced bulk density of the carbon nanostructures can be modulated to some degree by adjusting the carbon nanostructure growth conditions, including, for example, by changing the concentration of transition metal nanoparticle catalyst particles that are disposed on the growth substrate to initiate carbon nanotube growth. Suitable transition metal nanoparticle catalysts and carbon nanostructure growth conditions are outlined in more detail below.

As discussed above, the effective pore size of the carbon nanostructures can be controlled in some embodiments by altering the thickness of the carbon nanostructures, particularly by altering the dimensions of a carbon nanostructure flake material or layering carbon nanostructures upon one another to alter the through-plane thickness of a carbon nanostructure layer. Layering of carbon nanostructures can take place with agglomeration and densification of the carbon nanostructures (e.g., by producing a carbon nanostructure mat of a desired thickness) or without agglomeration and densification. Particularly, in some embodiments, the separation body can include one of more layers of a carbon nanostructure flake material. For example, in some embodiments, the separation body can include one or more layers of a carbon nanostructure mat, which can be made from a carbon nanostructure flake material.

Depending on the specific particulate material being sequestered in a particular separation process, the carbon nanostructures can be tailored to provide a range of effective pore sizes and separation affinities. Exemplary effective pore sizes for sequestering particular types of particulates are discussed below. Depending on the effective pore size, a range of operating pressures will be suitable, as also discussed below.

In some embodiments, particulates within the microfiltration range can be sequestered by the carbon nanostructures. As used herein, the microfiltration range refers to an effective pore size ranging between about 100 nm and about 1 micron. In exemplary embodiments, microfiltration can be accomplished by a single layer of carbon nanostructures (e.g., a single layer of carbon nanostructure flake material). Illustrative substances that can be removed in the microfiltration range can include, for example, clay, bacteria, large viruses, and suspended particles, such as dust. Effective operating pressures within the microfiltration range can be about 30 psi or less.

In some embodiments, particulates within the ultrafiltration range can be sequestered by the carbon nanostructures. As used herein, the ultrafiltration range refers to an effective pore size ranging between about 10 nm and about 100 nm. In exemplary embodiments, ultrafiltration can be accomplished by about two layers of carbon nanostructures. Illustrative substances that can be removed in the ultrafiltration range can include, for example, viruses, proteins, starches, colloids, silica, organic molecules, dyes, and fats. Effective operating pressures within the ultrafiltration range can be about 20 psi to about 100 psi.

In some embodiments, particulates within the nanofiltration range can be sequestered by the carbon nanostructures. As used herein, the nanofiltration range refers to an effective pore size ranging between about 5 nm and about 10 nm. In exemplary embodiments, nanofiltration can be accomplished by about three to about five layers of carbon nanostructures. Illustrative substances that can be removed in the nanofiltration range can include, for example, sugars, pesticides, herbicides, small organic molecules, and divalent ions. Effective operating pressures within the nanofiltration range can be about 50 psi to about 300 psi.

In still other embodiments, the separation membranes described herein can be used to carry out reverse osmosis purification processes. As used herein, the term “reverse osmosis” refers a separation process in which a fluid phase passes from an area of high concentration of a dissolved substance to an area of low concentration. For example, in a reverse osmosis process, a salt solution can be liberated of its dissolved salt by passing the fluid phase through a semi-permeable membrane under an applied pressure exceeding the osmotic pressure, leaving the dissolved salt behind. In various embodiments, the effective pore size of carbon nanostructures being used in reverse osmosis processes can range between about 1 nm and about 5 nm. Effective operating pressures during reverse osmosis purification processes using a separation membrane formed from carbon nanostructures can range between about 225 psi and about 1000 psi. Illustrative substances that can removed during reverse osmosis purification processes can include, for example, monovalent salts.

In some embodiments, the separation body of the separation membranes described herein can have at least an effective pore size ranging between about 1 micron and about 100 nm. In some or other embodiments, the separation body of the separation membranes described herein can have at least an effective pore size ranging between about 100 nm and about 10 nm. In some or other embodiments, the separation body of the separation membranes described herein can have at least an effective pore size ranging between about 10 nm and about 5 nm. In some or other embodiments, the separation body of the separation membranes described herein can have at least an effective pore size ranging between about 5 nm and about 1 nm. Separation bodies having combinations of the foregoing effective pore sizes can also be utilized, as discussed hereinafter.

In some embodiments, carbon nanostructures having any combination and subranges of the foregoing effective pore sizes can be configured in series with one another to produce a separation body. More specifically, in some embodiments, the separation body of the separation membranes described herein can include a plurality of carbon nanostructure layers that are in direct contact with one another and configured in series with a progressively decreasing effective pore size in a direction of intended fluid flow. As used herein, the term “progressively decreasing” means that along the separation body in the direction of fluid flow, the effective pore size either remains substantially constant or decreases, but it does not increase. The progressive decrease in effective pore size can occur in a gradient fashion along the direction of intended fluid flow, or it can occur in a step-wise fashion. With a step-wise decrease in effective pore size, there can be regions where the effective pore size remains substantially constant before beginning to decrease again.

In more specific embodiments, the separation body can include a plurality of carbon nanostructure layers that are in direct contact with one another and that are configured to provide filtration in the microfiltration, ultrafiltration, and nanofiltration regions. More specifically, in some embodiments, the separation body can have a first carbon nanostructure layer having an effective pore size ranging between about 1 micron and about 100 nm, a second carbon nanostructure layer having an effective pore size ranging between about 100 nm and about 10 nm, and a third carbon nanostructure layer having an effective pore size ranging between about 10 nm and about 5 nm. In further embodiments, the separation body can include a plurality of carbon nanostructure layers that are configured to provide filtration by reverse osmosis. More specifically, in some embodiments, the separation body can further include a fourth carbon nanostructure layer having an effective pore size ranging between about 5 nm and about 1 nm.

FIG. 4 shows a schematic of an illustrative separation membrane having carbon nanostructures that progressively decrease in effective pore size in the direction of intended fluid flow. The direction of forward fluid flow through the separation membrane is denoted with arrows in FIG. 4. Separation membrane 200 includes microfiltration region 210 where particulates 211 are sequestered, ultrafiltration region 220 where particulates 221 are sequestered, nanofiltration region 230 where particulates 231 are sequestered, and reverse osmosis region 240 where particulates 241 remain after the fluid phase passes exits. As shown in FIG. 4, the quantity of particulates is gradually decreased along the length of separation membrane 200. After exiting separation membrane 200 via reverse osmosis region 240, a particulate-free fluid phase can be obtained, at least to the extent that any remaining particulates are smaller than the effective pore size of reverse osmosis region 240. It is to be recognized that the smallest particulates being removed by separation membrane 200 is a matter of design choice. For example, in some embodiments, separation membrane 200 can omit reverse osmosis region 240, such that any particulates remaining in a fluid phase exiting separation membrane 200 are smaller in size than the effective pore size of nanofiltration region 230. In some embodiments, both reverse osmosis region 240 and nanofiltration region 230 can be omitted from separation membrane 200.

Each filtration region within separation membrane 200 can contain only carbon nanostructures that provide a single effective pore size throughout the filtration region, or two or more distinct sets of effective pore sizes can be present within a single filtration region, albeit with a progressively decreasing effective pore size in the direction of intended fluid flow. For example, in some embodiments, microfiltration region 210 can include a first subregion having carbon nanostructures with an effective pore size of about 1 micron to about 500 nm and a second subregion having an effective pore size of about 500 nm to about 100 nm. Other combinations of effective pore size subranges within any of the above filtration regions are contemplated and can be implemented in a particular separation process by one having ordinary skill in the art and the benefit of the present disclosure.

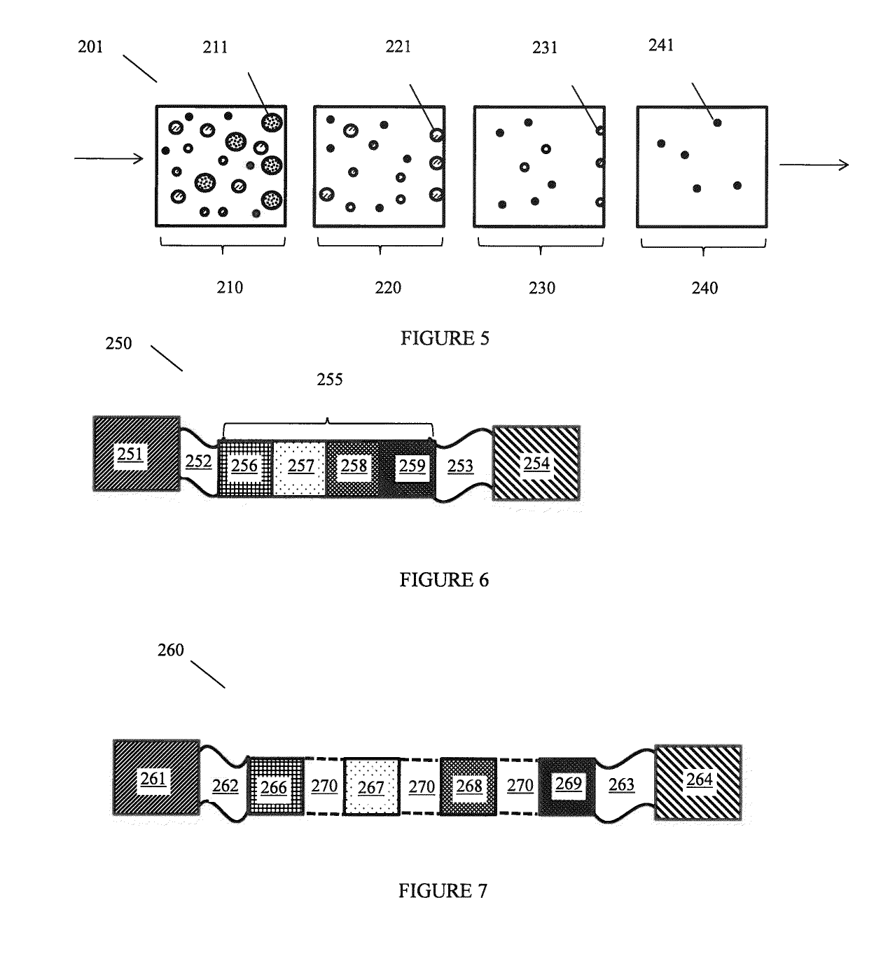

In alternative embodiments, a plurality of carbon nanostructure layers of progressively decreasing effective pore size in the direction of intended fluid flow and that are spaced apart from one another can also be used. Such spaced apart configurations of the carbon nanostructure layers will be considered in more detail in the separation systems described hereinbelow. FIG. 5 shows a schematic of an illustrative separation stream 201 in which the separation regions of FIG. 4 are spaced apart from one another as multiple separation bodies in series, each with a progressively decreasing effective pore size in the direction of intended fluid flow.

In addition to layering carbon nanostructures to alter their effective pore size, various additional modifications can be made to the carbon nanostructures to affect their porosity and other properties. In some embodiments, an additive can be present within at least a portion of the carbon nanostructures. In some embodiments, the additive can be selected to establish the effective pore size within the carbon nanostructures. For example, the additive can be chosen such that it blocks the pores within carbon nanostructures that are smaller than the additive, thereby setting a minimum particulate size retained by the carbon nanostructures. Examples of suitable additives in this regard include any type of microparticle or nanoparticle having a designated size range that is within the range of expected pore sizes. The additive can either be removable from the carbon nanostructures, or the additive can be made to be non-removable by covalently bonding the additive to the carbon nanostructures. Non-covalently bound additives can also be non-removable, in some embodiments. Covalently bonding the additive to the carbon nanostructures may be desirable to limit removal of the additive when the separation membranes are backflushed during membrane regeneration. In some or other embodiments, additives can also be used to regulate another property of the separation membranes other than their effective pore size. For example, in some embodiments, antimicrobial particulates (e.g., silver nanoparticles) can be incorporated in the carbon nanostructures in order to improve their resistance to biofouling. Zinc, copper, and lanthanide particulates can also be used in a similar manner.

Similarly, in some embodiments, at least a portion of the carbon nanostructures in the separation body can be functionalized. The reactions used to functionalize the carbon nanostructures can involve the same types of reactions used to functionalize carbon nanotubes. A number of reactions suitable for functionalizing carbon nanotubes will be familiar to one having ordinary skill in the art and can be adapted to the functionalization of carbon nanostructures by one having the benefit of the present disclosure. For example, at least a portion of the carbon nanostructures in the separation body can be hydroxylated or carboxylated using techniques analogous to those used for functionalizing carbon nanotubes. Hydroxyl or carboxyl groups can increase the hydrophilicity or the carbon nanostructures and make them more amenable to filtration of an aqueous fluid.

In some embodiments, at least a portion of the carbon nanostructures in the separation body can be covalently bonded together. That is, when multiple carbon nanostructures are combined to make a carbon nanostructure layer, at least a portion of the carbon nanostructures can be covalently bonded to one another. Covalent bonding between the carbon nanostructures can take place via functional groups introduced as described above. For example, in some embodiments, carboxylic acid groups or hydroxyl groups introduced to the carbon nanostructures can be used to establish covalent bonds between the carbon nanostructures.

Before further discussing separation membranes containing carbon nanostructures and methods for their use in separation processes, separation systems including carbon nanostructures will be further described. The separation systems described herein can include at least one separation membrane, such as those depicted in FIG. 4, in which several carbon nanostructure layers are in direct contact with one another to produce a separation membrane with regions of progressively decreasing effective pore sizes. Multiple separation membranes can also be present in parallel in such systems in order to improve throughput. The separation systems can also include multiple separation membranes that are spaced apart from each other, such as in the fluid stream depicted in FIG. 5. Multiple fluid streams containing spaced apart separation membranes operating in parallel can also be used in some embodiments to improve system throughput as well. Generally, the separation systems can include any embodiment and combination of carbon nanostructures described hereinabove.

In some embodiments, separation systems described herein can include at least one separation membrane having a separation body, where the separation body has an effective pore size of about 1 micron or less and provides a tortuous path for passage of a substance therethrough. The separation body includes carbon nanostructures. The carbon nanostructures include a plurality of carbon nanotubes that are branched, crosslinked, and share common walls with one another. The carbon nanostructures can include any of the additional features described herein.

In some embodiments, the separation body of the systems can include a plurality of carbon nanostructure layers that are in direct contact with one another and are configured in series with a progressively decreasing pore size in a direction of intended fluid flow. In more specific embodiments, the separation body can include a first carbon nanostructure layer having an effective pore size ranging between about 1 micron and about 100 nm, a second carbon nanostructure layer having an effective pore size ranging between about 100 nm and about 10 nm, and a third carbon nanostructure layer having an effective pore size ranging between about 10 nm and about 5 nm. In some embodiments, the separation body can also include a fourth carbon nanostructure layer having an effective pore size ranging between about 5 nm and about 1 nm.

FIG. 6 shows a block diagram schematic of separation system 250 having a separation body with multiple carbon nanostructure layers that are in direct contact with one another. As shown in FIG. 6, separation body 255 contains carbon nanostructure layers 256-259, each with a progressively decreasing effective pore size, as generally described above. A fluid phase enters separation body 255 from source 251 via fluid inlet 252, and a fluid phase having a decreased quantity of particulates exits via fluid outlet 253 and is collected in storage vessel 254. Although FIG. 6 has depicted separation system 250 as storing a purified fluid phase in storage vessel 254, it is to be recognized that the fluid phase may be conveyed direction to its intended end destination in a related manner. Although not depicted, various pumps can be present in separation system 250 to promote the passage of the fluid phase through separation body 255.

In some embodiments, the at least one separation membrane of the separation systems described herein can include a plurality of carbon nanostructure layers that are spaced apart from one another and are configured in series with a progressively decreasing effective pore size in a direction of intended fluid flow. That is, in some embodiments, the separation systems can include multiple separation membranes that are spaced apart from one another and contain carbon nanostructures. In more specific embodiments, the at least one separation membrane can include a first separation membrane containing a first carbon nanostructure layer having an effective pore size ranging between about 1 micron and about 100 nm, a second separation membrane having a second carbon nanostructure layer having an effective pore size ranging between about 100 nm and about 10 nm, and a third separation membrane having a third carbon nanostructure layer having an effective pore size ranging between about 10 nm and about 5 nm. In some embodiments, the at least one separation membrane can also include a fourth separation membrane having a fourth carbon nanostructure layer having an effective pore size an effective pore size ranging between about 5 nm and about 1 nm.

FIG. 7 shows a block diagram schematic of separation system 260 having multiple separation membranes that are spaced apart from one another and contain carbon nanostructures. As shown in FIG. 7, separation system 260 contains separation membranes 266-269 that are fluidly connected to one another in series, each containing carbon nanostructures that produce a progressively decreasing effective pore size, as generally described above. A fluid phase enters system 260 from source 261 via fluid inlet 262, and a fluid phase having a decreased quantity of particulates exits via fluid outlet 263 and is collected in storage vessel 264. Although FIG. 7 has depicted system 260 as storing a purified fluid phase in storage vessel 264, it is again to be recognized that the fluid phase may be conveyed directly to its intended end destination in a related manner. Each of separation membranes 266-269 are fluidly connected to one another via fluid conduits 270 extending therebetween. In addition, various pumps can be present in system 260 to promote the passage of the fluid phase therein.

In some embodiments, the separation membranes described herein can further include an electrical connection configured to apply an electric current to at least a portion of the separation body. Benefits of including an electrical connection to the separation membranes can include the ability to clean the separation membranes through application of an electrical current and the ability to conduct charge-based separation processes. The electric current (AC or DC) can be supplied continuously to the separation membranes, or the electric current can be supplied periodically, such as on an as-needed basis for cleaning, for example. Triggers for indicating that the separation membranes need to be cleaned can include, for example, a fluid flow rate through the separation membranes that falls below a pre-set level and/or a change in a measured electrical property of the separation membrane (e.g., such as a measured resistivity that exceeds a certain threshold limit or a threshold capacitance value). In this regard, carbon nanostructures can be particularly desirable, since they can be electrically conductive by themselves, and their measured resistivity or capacitance values can change significantly upon the incorporation of foreign substances therein, such as sequestered particulate matter.

In some embodiments, methods for purifying a fluid phase are described herein. The fluid phase can be a liquid phase in some embodiments, or a gas phase in other embodiments. In various embodiments, the methods can include providing at least one separation membrane containing a separation body having an effective pore size of about 1 micron or less and providing a tortuous path for passage of a substance therethrough, passing a fluid phase containing particulate matter through the at least one separation membrane, sequestering at least a portion of the particulate matter in at least a portion of the at least one separation membrane, and eluting the fluid phase from the at least one separation membrane. The eluted fluid phase has a decreased quantity of particulate matter therein. The separation body includes carbon nanostructures. Each carbon nanostructure contains a plurality of carbon nanotubes that are branched, crosslinked, and share common walls with one another.

It is not believed that the type of particulate matter being sequestered within the separation membranes disclosed herein is particularly limited. Illustrative types of particulate matter that can be separated from a fluid phase using a separation membrane of the present embodiments is described in more detail hereinabove.

After a certain period of time has elapsed and a quantity of particulate matter has accumulated within the at least one separation membrane, the particulate matter may need to be removed in order to allow continued particulate separation to take place. Otherwise, the separation membrane can become clogged if too much particulate matter accumulates. Removal of the accumulated particulate matter can take place by various techniques, some of which are discussed hereinafter.

In some embodiments, the methods can include backflushing the at least one separation membrane to remove at least a portion of the particulate matter therefrom. Once the unwanted particulate matter has been removed from the separation membrane, fluid flow in the forward direction can then be resumed. In some embodiments, two or more separation membranes can be operated in parallel, such that at least one of the separation membranes is always being operated in the forward direction, thereby allowing the separation process to take place on a continuous basis. In some embodiments, one or more of the separation membranes can be backflushed on a continuous basis, while the remaining separation membranes are being operated in the forward direction, and in other embodiments, one or more of the separation membranes can be backflushed only on an as-needed basis.

In some embodiments, the methods can include chemically treating the at least one separation membrane to remove at least a portion of the particulate matter therefrom. The type of chemical treatment being applied to the at least one separation membrane is not believed to be particularly limited and can depend on the type of particulate matter that is being sequestered by the carbon nanostructures. Given the knowledge of the type of particulate sequestered within a carbon nanostructure, one of ordinary skill in the art will be able to choose a chemical treatment to affect its removal. Illustrative chemical treatments that can remove various types of particulate matter from the separation membranes described herein can include, for example, acids, mild oxidants, and the like. Carbon nanostructures can be advantageous in this regard, since they have limited reactivity against many of the chemical agents commonly used in treating conventional separation membranes. Conventional separation membranes, often made from polymers, can be susceptible to chemical attack, thereby reducing the separation membrane's lifetime.

In some embodiments, the methods can include applying an electric current to at least a portion of the at least one separation membrane to remove at least a portion of the particulate matter therefrom. As discussed above, the electric current being supplied to the separation membranes can be an alternating current or direct current, and it can be supplied continuously or on an as-needed basis.

In various embodiments, the separation membranes described herein can include a plurality of carbon nanostructure layers, which can be formed from the carbon nanostructure flake materials described above. A further description of such carbon nanostructure layers is provided hereinafter.

Upon combining a plurality of carbon nanostructures together to form a carbon nanostructure layer and densifying, the carbon nanostructure layer can be robust enough for isolation as a freestanding monolithic structure. That is, once the carbon nanostructures are agglomerated together in the carbon nanostructure layer, they do not tend to break apart from one another (e.g., to reform a discrete carbon nanostructure flake material or like particulate). In some embodiments, the plurality of carbon nanostructures can be non-covalently held together, such as through van der Waals forces. In some or other embodiments, at least a portion of the plurality of carbon nanostructures in the carbon nanostructure layer can be covalently bonded together. For example, in some embodiments, the carbon nanostructures in the carbon nanostructure layer can all be covalently bonded to a polymer that covalently links the carbon nanostructures together. However, in other embodiments, the carbon nanostructure layer can be free of a polymer that binds the carbon nanostructures together. In some such embodiments, a small molecule linker can be used in a substantially equivalent manner to covalently bond the carbon nanostructures together. Embodiments in which the carbon nanostructures are non-covalently held together can be free of a polymer as well.

Various additives can also be found in or on the carbon nanostructures making up the carbon nanostructure layers described herein. Additives that can be present include, but are not limited to, a coating on the carbon nanotubes, a filler material in the interstitial space of the carbon nanostructures, transition metal nanoparticles, residual growth substrate that is not adhered to the carbon nanostructure, and any combination thereof. In some embodiments, certain additives can be covalently bonded to at least a portion of the carbon nanotubes in at least some of the carbon nanostructures. It is not anticipated that residual growth substrate will be covalently bonded to the carbon nanostructure in the embodiments described herein, since the carbon nanostructure has been harvested from the growth substrate, as described hereinafter.

Coatings can be applied to the carbon nanotubes of the carbon nanostructures before or after removal of the carbon nanostructures from their growth substrates. Application of a coating before removal of the carbon nanostructures from their growth substrates can, for example, protect the carbon nanotubes during the removal process or facilitate the removal process. In other embodiments, a coating can be applied to the carbon nanotubes of the carbon nanostructures after removal of the carbon nanostructures from their growth substrates. Application of a coating to the carbon nanotubes of the carbon nanostructures after removal from their growth substrates can desirably facilitate handling and storage of the carbon nanostructures. In some embodiments, a coating on the carbon nanotubes can desirably facilitate agglomeration of the carbon nanostructures with one another to form a carbon nanostructure layer. In particular, coating the carbon nanostructures can desirably promote the consolidation or densification of the carbon nanostructures. Higher densities can desirably facilitate the processibility of the carbon nanostructures.

In some embodiments, the coating can be covalently bonded to the carbon nanotubes of the carbon nanostructures. In some or other embodiments, the carbon nanotubes can be functionalized before or after removal of the carbon nanostructures from their growth substrates so as to provide suitable reactive functional groups for forming such a coating. Suitable processes for functionalizing the carbon nanotubes of a carbon nanostructure are usually similar to those that can be used to functionalize individual carbon nanotubes and will be familiar to a person having ordinary skill in the art. In various embodiments, suitable techniques for functionalizing the carbon nanotubes of the carbon nanostructures can include, for example, reacting the carbon nanostructures with an oxidant, such as KMnO₄, H₂O₂, HNO₃ or any combination thereof. In other embodiments, the coating can be non-covalently bonded to the carbon nanotubes of the carbon nanostructures. That is, in such embodiments, the coating can be physically disposed on the carbon nanotubes.

In some embodiments, the coating on the carbon nanotubes of the carbon nanostructures can be a polymer coating. Suitable polymer coatings are not believed to be particularly limited and can include polymers such as, for example, an epoxy, a polyester, a vinylester polymer, a polyetherimide, a polyetherketoneketone, a polyphthalamide, a polyetherketone, a polyetheretherketone, a polyimide, a phenol-formaldehyde polymer, a bismaleimide polymer, an acrylonitrile-butadiene-styrene (ABS) polymer, a polycarbonate, a polyethyleneimine, a polyurethane, a polyvinylchloride, a polystyrene, a polyolefin, a polypropylene, a polyethylene, a polytetrafluoroethylene, and any combination thereof. Other polymer coatings can be envisioned by one having ordinary skill in the art. In some embodiments, the polymer coating can be covalently bonded to the carbon nanotubes of the carbon nanostructure, as generally discussed above. In such embodiments, the resultant composition can include a block copolymer of the carbon nanostructure and the polymer coating. In other embodiments, the polymer coating can be non-covalently bonded to the carbon nanotubes of the carbon nanostructure. Further discussion of the formation of a polymer coating is provided hereinbelow.

In addition to polymer coatings, other types of coatings can also be present. Other types of coatings can include, for example, metal coatings and ceramic coatings. Surfactant coatings can also be present in some embodiments.

In some or other embodiments, there can be a filler or other additive material present in at least the interstitial space between the carbon nanotubes of the carbon nanostructures (i.e., on the interior of the carbon nanostructures). The additive material can be present alone or in combination with a coating on the carbon nanotubes of the carbon nanostructures. When used in combination with a coating, the additive material can also be located on the exterior of the carbon nanostructures within the coating, in addition to being located within the interstitial space of the carbon nanostructures. Introduction of an additive material within the interstitial space of the carbon nanostructures or elsewhere within the carbon nanostructures can result in further modification of the properties of the carbon nanostructures. Without limitation, the inclusion of an additive material within the carbon nanostructures can result in modification of the carbon nanostructure's density, thermal properties, spectroscopic properties, mechanical strength, and the like. It is not believed that individual or bundled carbon nanotubes are capable of carrying an additive material in a like manner, since they lack a permanent interstitial space on the nanotube exterior to contain the additive material. Although there is empty space on the carbon nanotube interior, it is believed to be either very difficult or impossible to place an additive material in that location.

In some or other embodiments, the carbon nanostructures can contain a plurality of transition metal nanoparticles, where the transition metal nanoparticles can represent a catalyst that was used in synthesizing the carbon nanostructures. In some embodiments, the transition metal nanoparticles can be coated with an anti-adhesive coating that limits their adherence to a growth substrate or the carbon nanostructure to a growth substrate, as shown in FIG. 9. Suitable anti-adhesive coatings are discussed in more detail below. In various embodiments, the anti-adhesive coating can be carried along with the transition metal nanoparticles as the carbon nanostructures and the transition metal nanoparticles are removed from the growth substrates. In other embodiments, the anti-adhesive coating can be removed from the transition metal nanoparticles before or after they are incorporated into the carbon nanostructures. In still other embodiments, the transition metal nanoparticles can initially be incorporated into the carbon nanostructures and then subsequently removed. For example, in some embodiments, at least a portion of the transition metal nanoparticles can be removed from the carbon nanostructures by treating the carbon nanostructures with a mineral acid.

In some or other embodiments, the carbon nanostructures described herein can contain a growth substrate that is not adhered to the carbon nanostructure. As described further hereinbelow, the carbon nanostructures that are initially formed can sometimes contain fragmented growth substrate that is produced during the carbon nanostructure removal process. In some embodiments, the fragmented growth substrate can remain with the carbon nanostructures. In other embodiments, the growth substrate can be subsequently removed from the carbon nanostructures, as described in more detail below.

Due to their greater dispersibility compared to individualized carbon nanotubes, carbon nanostructures can sometimes be dispersed in a fluid phase without using a surfactant. Accordingly, in some embodiments, the carbon nanostructure layers described herein can be free of a surfactant.

Methods for forming a carbon nanostructure layer can include an operation of depositing a plurality of carbon nanostructures upon a surface to form the carbon nanostructure layer. In this regard, several embodiments are contemplated, as discussed further hereinbelow.

In some embodiments, methods for forming a carbon nanostructure layer are described herein. The methods can include providing a plurality of carbon nanostructures that are free of a growth substrate adhered to each carbon nanostructure, and forming a carbon nanostructure layer by depositing the carbon nanostructures on a surface. The carbon nanostructures each contain a plurality of carbon nanotubes that are branched, crosslinked, and share common walls with one another, and at least a portion of the carbon nanotubes in each carbon nanostructure are aligned substantially parallel to one another.

Methods for forming the carbon nanostructure layers described herein can take place by any of the techniques through which conventional carbon nanotube mats are prepared. In this regard, suitable techniques for forming the carbon nanostructure layers can include, for example, filtration of a fluid dispersion of carbon nanostructures, electrophoretic deposition of carbon nanostructures, layer-by-layer deposition of the carbon nanostructures, ink jet printing, tape casting, evaporation of solvent from a fluid dispersion of carbon nanostructures, and the like. Other suitable techniques analogous to those used for producing carbon nanotube mats can be envisioned by one having ordinary skill in the art. Most desirably, methods for forming a carbon nanostructure layer can include filtering a fluid medium containing a plurality of the carbon nanostructures.

In some embodiments, methods described herein can further include dispersing the carbon nanostructures in a fluid medium prior to forming the carbon nanostructure layer. The fluid medium in which the carbon nanostructures are dispersed is not believed to be particularly limited and can include, for example, water or an organic solvent. In various embodiments, the carbon nanostructures can be dispersed in the fluid medium without using a surfactant. As discussed above, carbon nanostructures are much more dispersible in a fluid medium than are carbon nanotubes, most likely due to their significantly different molecular structure. In some embodiments, the methods can further include filtering the fluid medium containing the carbon nanostructures to collect the carbon nanostructure layer on a filter.

In some embodiments, methods described herein can further include forming a carbon nanostructure on a growth substrate, and removing the carbon nanostructure from the growth substrate. Thereafter, a plurality of the carbon nanostructures (e.g., in the form of a carbon nanostructure flake material) can be processed to form a carbon nanostructure layer, as generally described hereinabove.

In some embodiments, the methods can further include covalently bonding at least a portion of the carbon nanostructures to one another in the carbon nanostructure layer, as generally discussed above.

Production of a carbon nanostructure on a growth substrate and subsequent removal of the carbon nanostructure from the growth substrate by various techniques are now further described hereinbelow.

In some embodiments, processes described herein can include preparing a carbon nanostructure on a growth substrate with one or more provisions for removal of the carbon nanostructure once synthesis of the carbon nanostructure is complete. The provision(s) for removing the carbon nanostructure from the growth substrate can include one or more techniques selected from the group consisting of: (i) providing an anti-adhesive coating on the growth substrate, (ii) providing an anti-adhesive coating on a transition metal nanoparticle catalyst employed in synthesizing the carbon nanostructure, (iii) providing a transition metal nanoparticle catalyst with a counter ion that etches the growth substrate, thereby weakening the adherence of the carbon nanostructure to the growth substrate, and (iv) conducting an etching operation after carbon nanostructure synthesis is complete to weaken adherence of the carbon nanostructure to the growth substrate. Combinations of these techniques can also be used. In combination with these techniques, various fluid shearing or mechanical shearing operations can be carried out to affect the removal of the carbon nanostructure from the growth substrate.

In some embodiments, processes disclosed herein can include removing a carbon nanostructure from a growth substrate. In some embodiments, removing a carbon nanostructure from a growth substrate can include using a high pressure liquid or gas to separate the carbon nanostructure from the growth substrate, separating contaminants derived from the growth substrate (e.g., fragmented growth substrate) from the carbon nanostructure, collecting the carbon nanostructure with air or from a liquid medium with the aid of a filter medium, and isolating the carbon nanostructure from the filter medium. In various embodiments, separating contaminants derived from the growth substrate from the carbon nanostructure can take place by a technique selected from the group consisting of cyclone filtering, density separation, size-based separation, and any combination thereof. The foregoing processes are described in more detail hereinbelow.

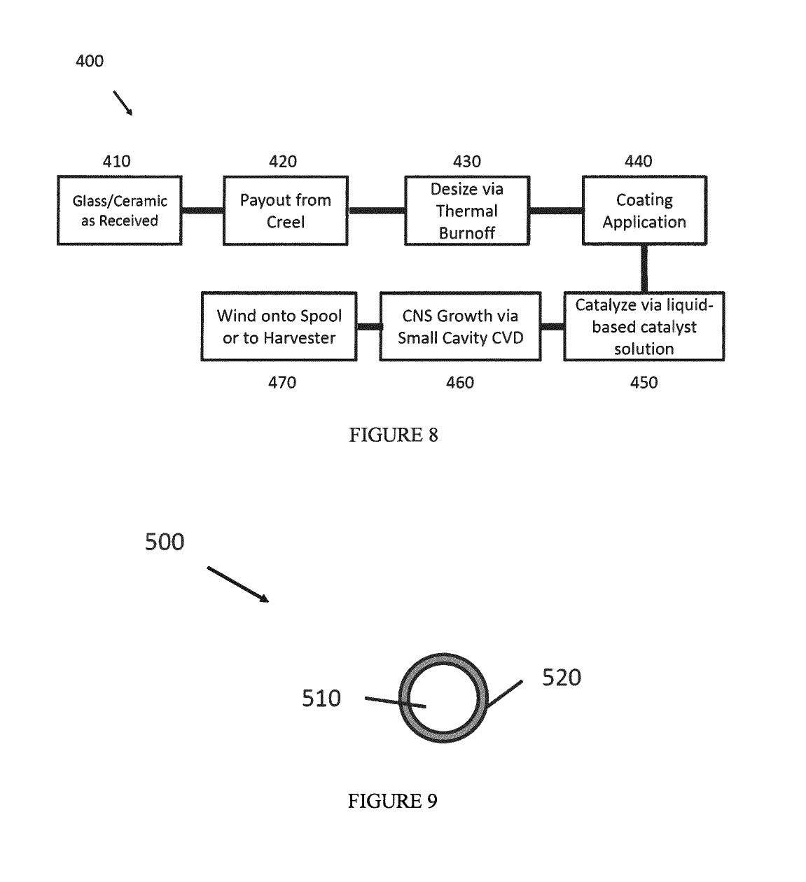

FIG. 8 shows a flow diagram of an illustrative carbon nanostructure growth process 400, which employs an exemplary glass or ceramic growth substrate 410. It is to be understood that the choice of a glass or ceramic growth substrate is merely exemplary, and the substrate can also be metal, an organic polymer (e.g., aramid), basalt fiber, or carbon, for example. In some embodiments, the growth substrate can be a fiber material of spoolable dimensions, thereby allowing formation of the carbon nanostructure to take place continuously on the growth substrate as the growth substrate is conveyed from a first location to a second location. Carbon nanostructure growth process 400 can employ growth substrates in a variety of forms such as fibers, tows, yarns, woven and non-woven fabrics, sheets, tapes, belts and the like. For convenience in continuous syntheses, tows and yarns are particularly convenient fiber materials.

Referring still to FIG. 8, such a fiber material can be meted out from a payout creel at operation 420 and delivered to an optional desizing station at operation 430. Desizing is ordinarily conducted when preparing carbon nanostructure-infused fiber materials in order to increase the degree of infusion of the carbon nanostructure to the fiber material. However, when preparing an isolated carbon nanostructure, desizing operation 430 can be skipped, for example, if the sizing promotes a decreased degree of adhesion of the transition metal nanoparticle catalyst and/or carbon nanostructure to the growth substrate, thereby facilitating removal of the carbon nanostructure. Numerous sizing compositions associated with fiber substrates can contain binders and coupling agents that primarily provide anti-abrasive effects, but typically do not exhibit exceptional adhesion to fiber surface. Thus, forming a carbon nanostructure on a growth substrate in the presence of a sizing can actually promote subsequent isolation of the carbon nanostructure in some embodiments. For this reason, it can be beneficial to skip desizing operation 430, in some embodiments.

In some embodiments, an additional coating application can take place at operation 440. Additional coatings that can be applied in operation 440 include, for example, colloidal ceramics, glass, silanes, or siloxanes that can decrease catalyst and/or carbon nanostructure adhesion to the growth substrate. In some embodiments, the combination of a sizing and the additional coating can provide an anti-adhesive coating that can promote removal of the carbon nanostructure from the growth substrate. In some embodiments, the sizing alone can provide sufficient anti-adhesive properties to facilitate carbon nanostructure removal from the growth substrate, as discussed above. In some embodiments, the additional coating provided in operation 440 alone can provide sufficient anti-adhesive properties to facilitate carbon nanostructure removal from the growth substrate. In still further embodiments, neither the sizing nor the additional coating, either alone or in combination, provides sufficient anti-adhesive properties to facilitate carbon nanostructure removal. In such embodiments, decreased adhesion of the carbon nanostructure to the growth substrate can be attained by judicious choice of the transition metal nanoparticles used to promote growth of the carbon nanostructure on the growth substrate. Specifically, in some such embodiments, operation 450 can employ a catalyst that is specifically chosen for its poor adhesive characteristics.

Referring still to FIG. 8, after optional desizing operation 430 and optional coating operation 440, catalyst is applied to the growth substrate in operation 450, and carbon nanostructure growth is affected through a small cavity CVD process in operation 460. The resulting carbon nanostructure-infused growth substrate (i.e., a carbon nanostructure-infused fiber material) can be wound for storage and subsequent carbon nanostructure removal or immediately taken into a carbon nanostructure isolation process employing a harvester, as indicated in operation 470.

In some embodiments, the growth substrate can be modified to promote removal of a carbon nanostructure therefrom. In some embodiments, the growth substrate used for producing a carbon nanostructure can be modified to include an anti-adhesive coating that limits adherence of the carbon nanostructure to the growth substrate. The anti-adhesive coating can include a sizing that is commercially applied to the growth substrate, or the anti-adhesive coating can be applied after receipt of the growth substrate. In some embodiments, a sizing can be removed from the growth substrate prior to applying an anti-adhesive coating. In other embodiments, a sizing can be applied to a growth substrate in which a sizing is present.

In some embodiments, the carbon nanostructure can be grown on the growth substrate from a catalyst that includes a plurality of transition metal nanoparticles, as generally described hereinbelow. In some embodiments, one mode for catalyst application onto the growth substrate can be through particle adsorption, such as through direct catalyst application using a liquid or colloidal precursor-based deposition. Suitable transition metal nanoparticle catalysts can include any d-block transition metal or d-block transition metal salt. In some embodiments, a transition metal salt can be applied to the growth substrate without thermal treatments. In other embodiments, a transition metal salt can be converted into a zero-valent transition metal on the growth substrate through a thermal treatment.

In some embodiments, the transition metal nanoparticles can be coated with an anti-adhesive coating that limits their adherence to the growth substrate. As discussed above, coating the transition metal nanoparticles with an anti-adhesive coating can also promote removal of the carbon nanostructure from the growth substrate following synthesis of the carbon nanostructure. Anti-adhesive coatings suitable for use in conjunction with coating the transition metal nanoparticles can include the same anti-adhesive coatings used for coating the growth substrate. FIG. 9 shows an illustrative schematic of a transition metal nanoparticle coated with an anti-adhesive layer. As shown in FIG. 9, coated catalyst 500 can include core catalyst particle 510 overcoated with anti-adhesive layer 520. In some embodiments, colloidal nanoparticle solutions can be used in which an exterior layer about the nanoparticle promotes growth substrate to nanoparticle adhesion but discourages carbon nanostructure to nanoparticle adhesion, thereby limiting adherence of the carbon nanostructure to the growth substrate.

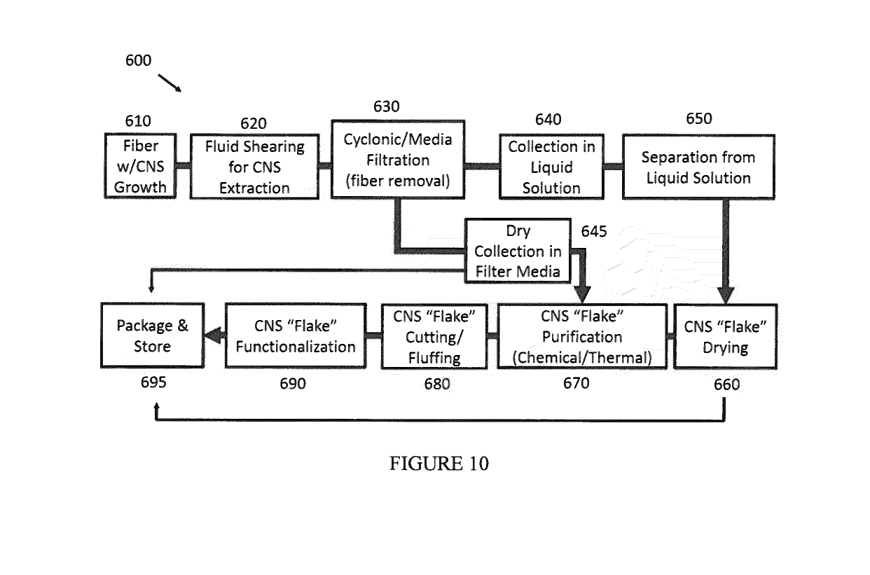

FIG. 10 shows a flow diagram of an illustrative process for isolating a carbon nanostructure from a growth substrate. As shown in FIG. 10, process 600 begins with a carbon nanostructure-infused fiber being provided in operation 610. Non-fibrous growth substrates onto which a carbon nanostructure has been grown can be used in a like manner. Fluid shearing can be conducted at operation 620 using a gas or a liquid in order to accomplish removal of the carbon nanostructure from the fiber material. In some cases, fluid shearing can result in at least a portion of the fiber material being liberated from the bulk fiber and incorporated with the free carbon nanostructure, while not being adhered thereto. If needed, in operation 630, the liberated carbon nanostructure can be subjected to cyclonic/media filtration in order to remove the non-adhered fiber material fragments. Density-based or size-based separation techniques can also be used to bring about separation of the carbon nanostructure from the non-adhered fiber material. In the case of gas shearing, the carbon nanostructure can be collected in dry form on a filter medium in operation 645. The resultant dry flake material collected in operation 645 can be subjected to any optional further chemical or thermal purification, as outlined further in FIG. 10. In the case of liquid shearing, the liquid can be collected in operation 640, and separation of the carbon nanostructure from the liquid can take place in operation 650, ultimately producing a dry flake material in operation 660. The carbon nanostructure flake material isolated in operation 660 can be similar to that produced in operation 645. After isolating the carbon nanostructure flake material in operation 660, it can be ready for packaging and/or storage in operation 695. In processes employing gas shearing to remove the carbon nanostructure, the carbon nanostructure can be dry collected in a filter at operation 645. Prior to packaging and/or storage in operation 695, the crude product formed by either shearing technique can undergo optional chemical and/or thermal purification in operation 670. These purification processes can be similar to those conducted when purifying traditional carbon nanotubes. By way of example, purification conducted in operation 670 can involve removal of a catalyst used to affect carbon nanostructure growth, such as, for example, through treatment with liquid bromine. Other purification techniques can be envisioned by one having ordinary skill in the art.

Referring still to FIG. 10, the carbon nanostructure produced by either shearing technique can undergo further processing by cutting or fluffing in operation 680. Such cutting and fluffing can involve mechanical ball milling, grinding, blending, chemical processes, or any combination thereof. Further optionally, in operation 690, the carbon nanostructure can be further functionalized using any technique in which carbon nanotubes are normally modified or functionalized. Suitable functionalization techniques in operation 690 can include, for example, plasma processing, chemical etching, and the like. Functionalization of the carbon nanostructure in this manner can produce chemical functional group handles that can be used for further modifications. For example, in some embodiments, a chemical etch can be employed to form carboxylic acid groups on the carbon nanostructure that can be used to bring about covalent attachment to any number of further entities including, for example, the matrix material of a composite material. In this regard, a functionalized carbon nanostructure can provide a superior reinforcement material in a composite matrix, since it can provide multiple sites for covalent attachment to the composite's matrix material in all dimensions.

In addition to facilitating the covalent attachment of a carbon nanostructure to the matrix of a composite material, functionalization of a carbon nanostructure can also allow other groups to be covalently attached to the carbon nanostructure. In some embodiments, access to other covalently linked entities such as synthetic or biopolymers can be realized via functional group handles produced in post-processing carbon nanostructure functionalization. For example, a carbon nanostructure can be linked to polyethylene glycol (e.g., through ester bonds formed from carboxylic acid groups on the carbon nanostructure) to provide a PEGylated carbon nanostructure, which can confer improved water solubility to the carbon nanostructure. In some embodiments, the carbon nanostructure can provide a platform for covalent attachment to biomolecules to facilitate biosensor manufacture. In this regard, the carbon nanostructure can provide improved electrical percolation pathways for enhanced detection sensitivity relative to other carbon nanotube-based biosensors employing individualized carbon nanotubes or even conventional carbon nanotube forests. Biomolecules of interest for sensor development can include, for example, peptides, proteins, enzymes, carbohydrates, glycoproteins, DNA, RNA, and the like.

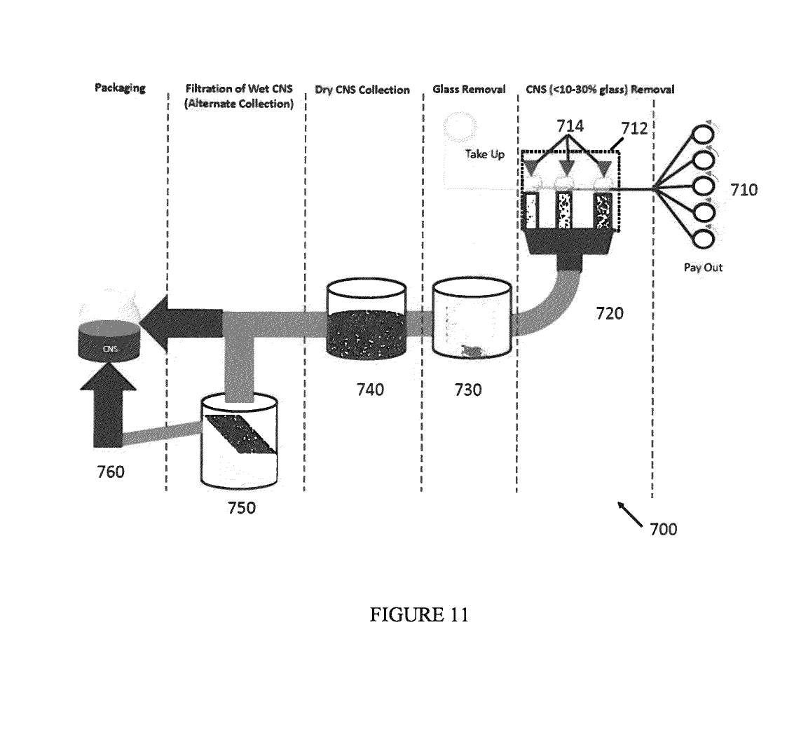

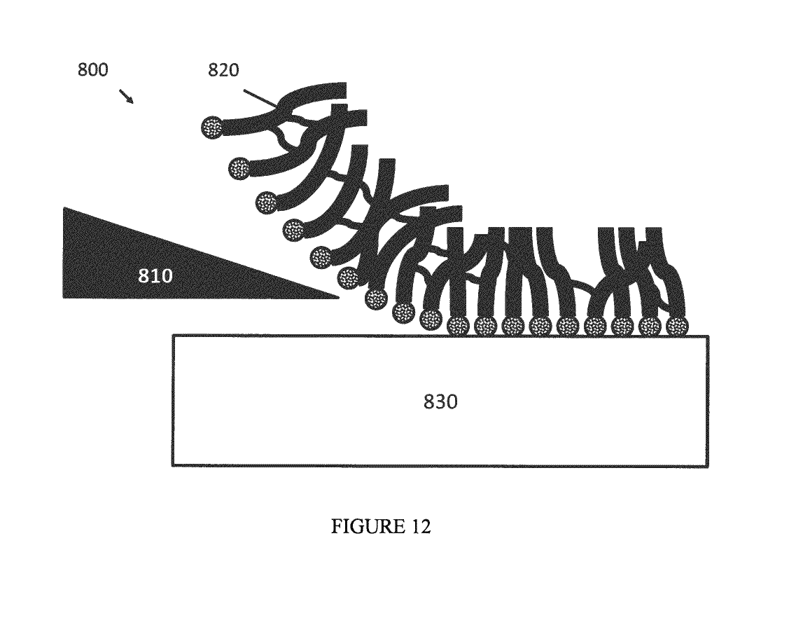

FIG. 11 shows an illustrative schematic further elaborating on the process demonstrated in FIG. 10. As illustrated in process 700 of FIG. 11, a single spool or multiple spools of a carbon nanostructure-laden fiber-type substrate is fed in operation 710 to removal chamber 712 using a pay-out and take-up system. Removal of the carbon nanostructure from the fiber-type substrate can be affected with a single or several pressurized air source tools 714, such as an air knife or air nozzle at operation 720. Such air source tools can be placed generally perpendicular to the spool(s), and the air can then be directed on to the fiber-type substrate carrying the carbon nanostructure. In some embodiments, the air source tool can be stationary, while in other embodiments, the air source tool can be movable. In embodiments where the air source tool is movable, it can be configured to oscillate with respect to the surface of the fiber-type substrate to improve the removal efficiency. Upon air impact, fiber tows and other bundled fiber-type substrates can be spread, thereby exposing additional surface area on the substrate and improving removal of the carbon nanostructure, while advantageously avoiding mechanical contact. In some embodiments, the integrity of the substrate can be sufficient to recycle the substrate in a continuous cycle of carbon nanostructure synthesis and removal. Thus, in some embodiments, the substrate can be in the form of a belt or a loop in which a carbon nanostructure is synthesized on the substrate, subsequently removed downstream, and then recycled for additional growth of a new carbon nanostructure in the location where the original carbon nanostructure was removed. In some embodiments, removal of the original carbon nanostructure can result in removal of the surface treatment that facilitated carbon nanostructure removal. Thus, in some embodiments, the substrate can again be modified after removal of the original carbon nanostructure to promote removal of the new carbon nanostructure, as generally performed according to the surface modification techniques described herein. The surface treatment performed on the substrate after the original carbon nanostructure is removed can be the same or different as the original surface treatment.

In some embodiments, the integrity of the substrate can be compromised during carbon nanostructure removal, and at least a portion of the substrate can become admixed with the carbon nanostructure while no longer being adhered thereto. Referring still to FIG. 11, fragmented substrate that has become admixed with the isolated carbon nanostructure can be removed in operation 730. In FIG. 11, operation 730 is depicted as taking place by cyclonic filtration, but any suitable solids separation technique can be used. For example, in some embodiments, sieving, differential settling, or other size-based separations can be performed. In other embodiments, density-based separations can be performed. In still other embodiments, a chemical reaction may be used, at least in part, to affect separation of the carbon nanostructure from growth substrate that is not adhered to the carbon nanostructure. Although FIG. 11 has depicted a single cyclonic filtration, multiple vacuum and cyclonic filtration techniques can be used in series, parallel, or any combination thereof to remove residual fragmented growth substrate from the carbon nanostructure. Such techniques can employ multiple stages of filter media and/or filtration rates to selectively capture the fragmented growth substrate while allowing the carbon nanostructure to pass to a collection vessel. The resultant carbon nanostructure can be either collected dry at operation 740 or collected as a wet sludge at operation 750. In some embodiments, the carbon nanostructure can be processed directly following the removal of fragmented growth substrate in operation 730 and packed into a storage vessel or shippable container in packaging operation 760. Otherwise, packaging can follow dry collection operation 740 or wet collection operation 750.

In embodiments where wet processing is employed, the carbon nanostructure can be mixed with about 1% to about 40% solvent in water and passed through a filter or like separation mechanism to separate the carbon nanostructure from the solvent. The resultant separated carbon nanostructure can be dried and packed or stored “wet” as a dispersion in a fluid phase. It has been observed that unlike individualized carbon nanotube solutions or dispersions, carbon nanostructures can advantageously form stable dispersions. In some embodiments, stable dispersions can be achieved in the absence of stabilizing surfactants, even with water as solvent. In some or other embodiments, a solvent can be used in combination with water during wet processing. Suitable solvents for use in conjunction with wet processing can include, but are not limited to, isopropanol (IPA), ethanol, methanol, and water.

As an alternative to fluid shearing, mechanical shearing can be used to remove the carbon nanostructure from the growth substrate in some embodiments. FIG. 12 shows an illustrative schematic demonstrating how mechanical shearing can be used to remove a carbon nanostructure and a transition metal nanoparticle catalyst from a growth substrate. As shown in FIG. 12, carbon nanostructure removal process 800 can employ mechanical shearing force 810 to remove both the carbon nanostructure and the transition metal nanoparticle catalyst from growth substrate 830 as monolithic entity 820. In some such embodiments, sizing and/or additional anti-adhesive coatings can be employed to limit carbon nanostructure and/or nanoparticle adhesion to the growth substrate, thereby allowing mechanical shear or another type of shearing force to facilitate removal of the carbon nanostructure from the growth substrate. In some embodiments, mechanical shear can be provided by grinding the carbon nanostructure-infused fiber with dry ice.

As another alternative to fluid shearing, in some embodiments, sonication can be used to remove the carbon nanostructure from the growth substrate.

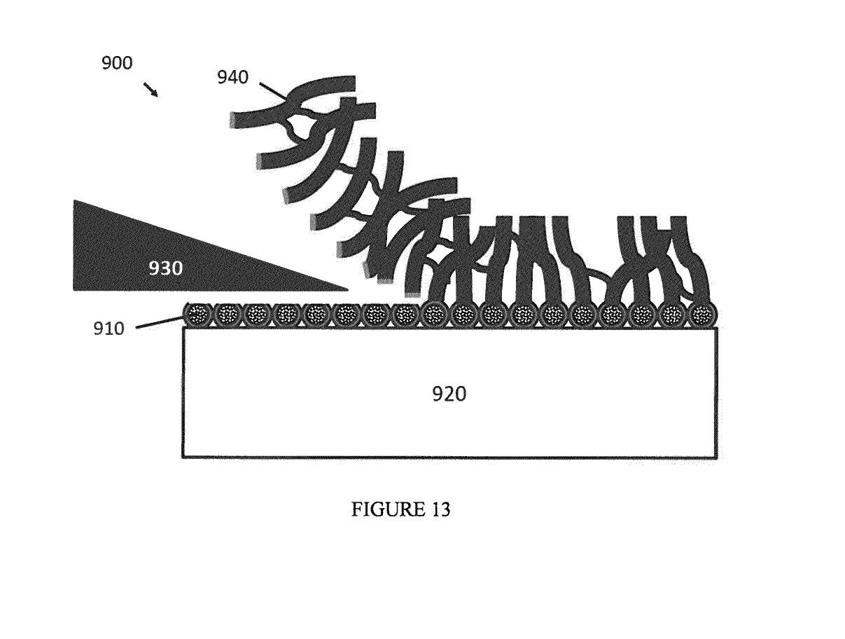

In some embodiments, the carbon nanostructure can be removed from the growth substrate without substantially removing the transition metal nanoparticle catalyst. FIG. 13 shows an illustrative schematic demonstrating carbon nanostructure removal process 900 in which a carbon nanostructure can be isolated from a growth substrate absent a transition metal nanoparticle catalyst. As shown in FIG. 13, carbon nanostructure 940 can be grown on growth substrate 920 using implanted transition metal nanoparticle catalyst 910. Thereafter, shear removal 930 of carbon nanostructure 940 leaves transition metal nanoparticle catalyst 910 behind on growth substrate 920. In some such embodiments, a layered catalyst can promote adhesion to the substrate surface, while decreasing carbon nanostructure to nanoparticle adhesion.

Although FIGS. 12 and 13 have depicted carbon nanostructure growth as taking place with basal growth from the catalyst, the skilled artisan will recognize that other mechanistic forms of carbon nanostructure growth are possible. For example, carbon nanostructure growth can also take place such that the catalyst resides distal to the growth substrate on the surface of the carbon nanostructure (i.e., tip growth) or somewhere between tip growth and basal growth. In some embodiments, predominantly basal growth can be selected to aid in carbon nanostructure removal from the growth substrate.

In alternative embodiments, removal of the carbon nanostructure from the growth substrate can take place by a process other than fluid shearing or mechanical shearing. In some embodiments, chemical etching can be used to remove the carbon nanostructure from the growth substrate. In some embodiments, the transition metal nanoparticle catalyst used to promote carbon nanostructure growth can be a transition metal salt containing an anion that is selected to etch the growth substrate, thereby facilitating removal of the carbon nanostructure. Suitable etching ions can include, for example, chlorides, sulfates, nitrates, nitrites, and fluorides. In some or other embodiments, a chemical etch can be employed independently from the catalyst choice. For example, when employing a glass substrate, a hydrogen fluoride etch can be used to weaken adherence of the carbon nanostructure and/or the transition metal nanoparticle catalyst to the substrate.

The carbon nanostructures disclosed herein comprise carbon nanotubes (CNTs) in a network having a complex structural morphology, which has been described in more detail hereinabove. Without being bound by any theory or mechanism, it is believed that this complex structural morphology results from the preparation of the carbon nanostructure on a substrate under CNT growth conditions that produce a rapid growth rate on the order of several microns per second. The rapid CNT growth rate, coupled with the close proximity of the CNTs to one another, can confer the observed branching, crosslinking, and shared wall motifs to the CNTs. In the discussion that follows, techniques for producing a carbon nanostructure bound to a fiber substrate are described. For simplicity, the discussion may refer to the carbon nanostructure disposed on the substrate interchangeably as CNTs, since CNTs represent the major structural component of carbon nanostructures.

In some embodiments, the processes disclosed herein can be applied to nascent fiber materials generated de novo before, or in lieu of, application of a typical sizing solution to the fiber material. Alternatively, the processes disclosed herein can utilize a commercial fiber material, for example, a tow, that already has a sizing applied to its surface. In such embodiments, the sizing can be removed to provide a direct interface between the fiber material and the synthesized carbon nanostructure, although a transition metal nanoparticle catalyst can serve as an intermediate linker between the two. After carbon nanostructure synthesis, further sizing agents can be applied to the fiber material as desired. For the purpose of carbon nanostructure isolation, any of the above mentioned sizing or coatings can be employed to facilitate the isolation process. Equally suitable substrates for forming a carbon nanostructure include tapes, sheets and even three dimensional forms which can be used to provide a shaped carbon nanostructure product. The processes described herein allow for the continuous production of CNTs that make up the carbon nanostructure network having uniform length and distribution along spoolable lengths of tow, tapes, fabrics and other 3D woven structures.

As used herein the term “fiber material” refers to any material which has fiber as its elementary structural component. The term encompasses fibers, filaments, yarns, tows, tows, tapes, woven and non-woven fabrics, plies, mats, and the like.

As used herein the term “spoolable dimensions” refers to fiber materials having at least one dimension that is not limited in length, allowing for the material to be stored on a spool or mandrel. Processes of described herein can operate readily with 5 to 20 lb. spools, although larger spools are usable. Moreover, a pre-process operation can be incorporated that divides very large spoolable lengths, for example 100 lb. or more, into easy to handle dimensions, such as two 50 lb. spools.

As used herein, the term “carbon nanotube” (CNT, plural CNTs) refers to any of a number of cylindrically-shaped allotropes of carbon of the fullerene family including single-walled carbon nanotubes (SWNTs), double-walled carbon nanotubes (DWNTs), multi-walled carbon nanotubes (MWNTs). CNTs can be capped by a fullerene-like structure or open-ended. CNTs include those that encapsulate other materials. CNTs can appear in branched networks, entangled networks, and combinations thereof. The CNTs prepared on the substrate within the carbon nanostructure can include individual CNT motifs from exclusive MWNTs, SWNTs, or DWNTs, or the carbon nanostructure can include mixtures of CNT these motifs.

As used herein “uniform in length” refers to an average length of CNTs grown in a reactor for producing a carbon nanostructure. “Uniform length” means that the CNTs have lengths with tolerances of plus or minus about 20% of the total CNT length or less, for CNT lengths varying from between about 1 micron to about 500 microns. At very short lengths, such as 1-4 microns, this error may be in a range from between about plus or minus 20% of the total CNT length up to about plus or minus 1 micron, that is, somewhat more than about 20% of the total CNT length. In the context of the carbon nanostructure, at least one dimension of the carbon nanostructure can be controlled by the length of the CNTs grown.

As used herein “uniform in distribution” refers to the consistency of density of CNTs on a growth substrate, such as a fiber material. “Uniform distribution” means that the CNTs have a density on the fiber material with tolerances of plus or minus about 10% coverage defined as the percentage of the surface area of the fiber covered by CNTs. This is equivalent to ±1500 CNTs/μm² for an 8 nm diameter CNT with 5 walls. Such a figure assumes the space inside the CNTs as fillable.

As used herein, the term “transition metal” refers to any element or alloy of elements in the d-block of the periodic table. The term “transition metal” also includes salt forms of the base transition metal element such as oxides, carbides, nitrides, and the like.

As used herein, the term “nanoparticle” or NP (plural NPs), or grammatical equivalents thereof refers to particles sized between about 0.1 to about 100 nanometers in equivalent spherical diameter, although the NPs need not be spherical in shape. Transition metal NPs, in particular, can serve as catalysts for CNT growth on the fiber materials.

As used herein, the term “sizing agent,” “fiber sizing agent,” or just “sizing,” refers collectively to materials used in the manufacture of fibers as a coating to protect the integrity of fibers, provide enhanced interfacial interactions between a fiber and a matrix material in a composite, and/or alter and/or enhance particular physical properties of a fiber.

As used herein, the term “material residence time” refers to the amount of time a discrete point along a fiber material of spoolable dimensions is exposed to CNT growth conditions during the CNS processes described herein. This definition includes the residence time when employing multiple CNT growth chambers.

As used herein, the term “linespeed” refers to the speed at which a fiber material of spoolable dimensions is fed through the CNT synthesis processes described herein, where linespeed is a velocity determined by dividing CNT chamber(s)' length by the material residence time.

In some embodiments, the CNT-laden fiber material includes a fiber material of spoolable dimensions and carbon nanotubes (CNTs) in the form of a carbon nanostructure grown on the fiber material.

Without being bound by any theory or mechanism, transition metal NPs, which serve as a CNT-forming catalyst, can catalyze CNT growth by forming a CNT growth seed structure. In one embodiment, the CNT-forming catalyst can remain at the base of the fiber material (i.e., basal growth). In such a case, the seed structure initially formed by the transition metal nanoparticle catalyst is sufficient for continued non-catalyzed seeded CNT growth without allowing the catalyst to move along the leading edge of CNT growth (i.e., tip growth). In such a case, the NP serves as a point of attachment for the CNS to the fiber material.

Compositions having CNS-laden fiber materials are provided in which the CNTs are substantially uniform in length. In the continuous process described herein, the residence time of the fiber material in a CNT growth chamber can be modulated to control CNT growth and ultimately, CNT and CNS length. These features provide a means to control specific properties of the CNTs grown and hence the properties of the CNS. CNT length can also be controlled through modulation of the carbon feedstock and carrier gas flow rates and reaction temperature. Additional control of the CNT properties can be obtained by modulating, for example, the size of the catalyst used to prepare the CNTs. For example, 1 nm transition metal nanoparticle catalysts can be used to provide SWNTs in particular. Larger catalysts can be used to prepare predominantly MWNTs.

Additionally, the CNT growth processes employed are useful for providing a CNS-laden fiber material with uniformly distributed CNTs while avoiding bundling and/or aggregation of the CNTs that can occur in processes in which pre-formed CNTs are suspended or dispersed in a solvent medium and applied by hand to the fiber material. In some embodiments, the maximum distribution density, expressed as percent coverage, that is, the surface area of fiber material that is covered, can be as high as about 55% assuming about 8 nm diameter CNTs with 5 walls. This coverage is calculated by considering the space inside the CNTs as being “fillable” space. Various distribution/density values can be achieved by varying catalyst dispersion on the surface as well as controlling gas composition and process speed. Typically for a given set of parameters, a percent coverage within about 10% can be achieved across a fiber surface. Higher density and shorter CNTs (e.g., less than about 100 microns in length) can be useful for improving mechanical properties, while longer CNTs (e.g., greater than about 100 microns in length) with lower density can be useful for improving thermal and electrical properties, although increased density still can be favorable. A lower density can result when longer CNTs are grown. This can be the result of the higher temperatures and more rapid growth causing lower catalyst particle yields.

CNS-laden fiber materials can include a fiber material such as filaments, a fiber yarn, a fiber tow, a fiber-braid, a woven fabric, a non-woven fiber mat, a fiber ply, and other 3D woven structures. Filaments include high aspect ratio fibers having diameters ranging in size from between about 1 micron to about 100 microns. Fiber tows are generally compactly associated bundles of filaments and are usually twisted together to give yarns.

Yarns include closely associated bundles of twisted filaments. Each filament diameter in a yarn is relatively uniform. Yarns have varying weights described by their ‘tex,’ expressed as weight in grams of 1000 linear meters, or denier, expressed as weight in pounds of 10,000 yards, with a typical tex range usually being between about 200 tex to about 2000 tex.

Tows include loosely associated bundles of untwisted filaments. As in yarns, filament diameter in a tow is generally uniform. Tows also have varying weights and the tex range is usually between 200 tex and 2000 tex. They are frequently characterized by the number of thousands of filaments in the tow, for example 12K tow, 24K tow, 48K tow, and the like.

Tapes are materials that can be assembled as weaves or can represent non-woven flattened tows. Tapes can vary in width and are generally two-sided structures similar to ribbon. CNT infusion can take place on one or both sides of a tape. CNS-laden tapes can resemble a “carpet” or “forest” on a flat substrate surface. However, the CNS can be readily distinguished from conventional aligned CNT forests due to the significantly higher degree of branching and crosslinking that occurs in the CNS structural morphology. Again, processes described herein can be performed in a continuous mode to functionalize spools of tape.

Fiber braids represent rope-like structures of densely packed fibers. Such structures can be assembled from yarns, for example. Braided structures can include a hollow portion or a braided structure can be assembled about another core material.

CNTs lend their characteristic properties such as mechanical strength, low to moderate electrical resistivity, high thermal conductivity, and the like to the CNS-laden fiber material. For example, in some embodiments, the electrical resistivity of a carbon nanotube-laden fiber material is lower than the electrical resistivity of a parent fiber material. Likewise, such properties can translate to the isolated CNS. More generally, the extent to which the resulting CNS-laden fiber expresses these characteristics can be a function of the extent and density of coverage of the fiber by the carbon nanotubes. Any amount of the fiber surface area, from 0-55% of the fiber can be covered assuming an 8 nm diameter, 5-walled MWNT (again this calculation counts the space inside the CNTs as fillable). This number is lower for smaller diameter CNTs and more for greater diameter CNTs. 55% surface area coverage is equivalent to about 15,000 CNTs/micron². Further CNT properties can be imparted to the fiber material in a manner dependent on CNT length, as described above. CNTs within the carbon nanostructure can vary in length from between about 1 micron to about 500 microns, including about 1 micron, about 2 microns, about 3 microns, about 4 micron, about 5, microns, about 6, microns, about 7 microns, about 8 microns, about 9 microns, about 10 microns, about 15 microns, about 20 microns, about 25 microns, about 30 microns, about 35 microns, about 40 microns, about 45 microns, about 50 microns, about 60 microns, about 70 microns, about 80 microns, about 90 microns, about 100 microns, about 150 microns, about 200 microns, about 250 microns, about 300 microns, about 350 microns, about 400 microns, about 450 microns, about 500 microns, and all values and sub-ranges in between. CNTs can also be less than about 1 micron in length, including about 0.5 microns, for example. CNTs can also be greater than 500 microns, including for example, about 510 microns, about 520 microns, about 550 microns, about 600 microns, about 700 microns and all values and subranges in between. It will be understood that such lengths accommodate the presence of crosslinking and branching and therefore the length may be the composite length measured from the base of the growth substrate up to the edges of the CNS.

CNSs described herein can also incorporate CNTs have a length from about 1 micron to about 10 microns. Such CNT lengths can be useful in application to increase shear strength. CNTs can also have a length from about 5 to about 70 microns. Such CNT lengths can be useful in applications for increased tensile strength if the CNTs are aligned in the fiber direction. CNTs can also have a length from about 10 microns to about 100 microns. Such CNT lengths can be useful to increase electrical/thermal properties as well as mechanical properties. CNTs having a length from about 100 microns to about 500 microns can also be beneficial to increase electrical and thermal properties. Such control of CNT length is readily achieved through modulation of carbon feedstock and inert gas flow rates coupled with varying linespeeds and growth temperatures.

In some embodiments, compositions that include spoolable lengths of CNS-laden fiber materials can have various uniform regions with different lengths of CNTs. For example, it can be desirable to have a first portion of CNS-laden fiber material with uniformly shorter CNT lengths to enhance shear strength properties, and a second portion of the same spoolable material with a uniform longer CNT length to enhance electrical or thermal properties.

Processes for rapid CNS growth on fiber materials allow for control of the CNT lengths with uniformity in continuous processes with spoolable fiber materials. With material residence times between 5 to 300 seconds, linespeeds in a continuous process for a system that is 3 feet long can be in a range anywhere from about 0.5 ft/min to about 36 ft/min and greater. The speed selected depends on various parameters as explained further below.

In some embodiments, a material residence time of about 5 seconds to about 30 seconds can produce CNTs having a length between about 1 micron to about 10 microns. In some embodiments, a material residence time of about 30 seconds to about 180 seconds can produce CNTs having a length between about 10 microns to about 100 microns. In still further embodiments, a material residence time of about 180 seconds to about 300 seconds can produce CNTs having a length between about 100 microns to about 500 microns. One skilled in the art will recognize that these ranges are approximate and that CNT length can also be modulated by reaction temperatures, and carrier and carbon feedstock concentrations and flow rates.

In some embodiments, continuous processes for CNS growth can include (a) disposing a carbon nanotube-forming catalyst on a surface of a fiber material of spoolable dimensions; and (b) synthesizing carbon nanotubes directly on the fiber material, thereby forming a CNS-laden fiber material. For a 9 foot long system, the linespeed of the process can range from between about 1.5 ft/min to about 108 ft/min. The linespeeds achieved by the process described herein allow the formation of commercially relevant quantities of CNS-laden fiber materials with short production times. For example, at 36 ft/min linespeed, the quantities of CNS-laden fibers (over 5% CNTs on fiber by weight) can exceed over 100 pound or more of material produced per day in a system that is designed to simultaneously process 5 separate tows (20 lb/tow). Systems can be made to produce more tows at once or at faster speeds by repeating growth zones.

As described further below the catalyst can be prepared as a liquid solution that contains CNT-forming catalyst that contains transition metal nanoparticles. The diameters of the synthesized nanotubes are related to the size of the transition metal nanoparticles as described above. In some embodiments, commercial dispersions of CNT-forming transition metal nanoparticle catalysts are available and can be used without dilution, and in other embodiments commercial dispersions of catalyst can be diluted. Whether to dilute such solutions can depend on the desired density and length of CNT to be grown as described above.

Carbon nanotube synthesis can be based on a chemical vapor deposition (CVD) process and occurs at elevated temperatures. The specific temperature is a function of catalyst choice, but will typically be in a range of about 500° C. to about 1000° C. This operation involves heating the fiber material to a temperature in the aforementioned range to support carbon nanotube synthesis.

CVD-promoted nanotube growth on the catalyst-laden fiber material is then performed. The CVD process can be promoted by, for example, a carbon-containing feedstock gas such as acetylene, ethylene, methane, and/or propane. The CNT synthesis processes generally use an inert gas (nitrogen, argon, helium) as a primary carrier gas. The carbon feedstock is generally provided in a range from between about 0% to about 50% of the total mixture. A substantially inert environment for CVD growth is prepared by removal of moisture and oxygen from the growth chamber.

The operation of disposing a catalyst on the fiber material can be accomplished by spraying or dip coating a solution or by gas phase deposition via, for example, a plasma process. Thus, in some embodiments, after forming a solution of a catalyst in a solvent, catalyst can be applied by spraying or dip coating the fiber material with the solution, or combinations of spraying and dip coating. Either technique, used alone or in combination, can be employed once, twice, thrice, four times, up to any number of times to provide a fiber material that is sufficiently uniformly coated with CNT-forming catalyst. When dip coating is employed, for example, a fiber material can be placed in a first dip bath for a first residence time in the first dip bath. When employing a second dip bath, the fiber material can be placed in the second dip bath for a second residence time. For example, fiber materials can be subjected to a solution of CNT-forming catalyst for between about 3 seconds to about 90 seconds depending on the dip configuration and linespeed. Employing spraying or dip coating processes, a fiber material with a surface density of catalyst of less than about 5% surface coverage to as high as about 80% coverage, in which the CNT-forming catalyst nanoparticles are nearly monolayer. In some embodiments, the process of coating the CNT-forming catalyst on the fiber material should produce no more than a monolayer. For example, CNT growth on a stack of CNT-forming catalyst can erode the degree of infusion of the CNT to the fiber material. In other embodiments, the transition metal catalyst can be deposited on the fiber material using evaporation techniques, electrolytic deposition techniques, and other deposition processes, such as addition of the transition metal catalyst to a plasma feedstock gas as a metal organic, metal salt or other composition promoting gas phase transport.

Because processes for growing carbon nanostructures are designed to be continuous, a spoolable fiber material can be dip-coated in a series of baths where dip coating baths are spatially separated. In continuous processes in which nascent fibers are being generated de novo, dip bath or spraying of CNT-forming catalyst can be the first step. In other embodiments, the CNT-forming catalyst can be applied to newly formed fibers in the presence of other sizing agents. Such simultaneous application of CNT-forming catalyst and other sizing agents can provide the CNT-forming catalyst in the surface of the sizing on the fiber material to create a poorly adhered CNT coating.

The catalyst solution employed can be a transition metal nanoparticle which can be any d-block transition metal, as described above. In addition, the nanoparticles can include alloys and non-alloy mixtures of d-block metals in elemental form or in salt form, and mixtures thereof. Such salt forms include, without limitation, oxides, carbides, acetates, and nitrides. Non-limiting exemplary transition metal NPs include Ni, Fe, Co, Mo, Cu, Pt, Au, and Ag and salts thereof and mixtures thereof. In some embodiments, such CNT-forming catalysts are disposed on the fiber by applying or infusing a CNT-forming catalyst directly to the fiber material simultaneously with barrier coating deposition. Many of these transition metal catalysts are readily commercially available from a variety of suppliers, including, for example, Sigma Aldrich (St. Louis, Mo.) or Ferrotec Corporation (Bedford, N.H.).

Catalyst solutions used for applying the CNT-forming catalyst to the fiber material can be in any common solvent that allows the CNT-forming catalyst to be uniformly dispersed throughout. Such solvents can include, without limitation, water, acetone, hexane, isopropyl alcohol, toluene, ethanol, methanol, tetrahydrofuran (THF), cyclohexane or any other solvent with controlled polarity to create an appropriate dispersion of the CNT-forming catalyst nanoparticles. Concentrations of CNT-forming catalyst can be in a range from about 1:1 to 1:10000 catalyst to solvent. Such concentrations can be used when the barrier coating and CNT-forming catalyst are applied simultaneously as well.

In some embodiments heating of the fiber material can be at a temperature that is between about 500° C. and about 1000° C. to synthesize carbon nanotubes after deposition of the CNT-forming catalyst. Heating at these temperatures can be performed prior to or substantially simultaneously with introduction of a carbon feedstock for CNT growth.

In some embodiments, the processes for producing a carbon nanostructure include removing a sizing agent from a fiber material, applying an adhesion-inhibiting coating (i.e., an anti-adhesive coating) conformally over the fiber material, applying a CNT-forming catalyst to the fiber material, heating the fiber material to at least 500° C., and synthesizing carbon nanotubes on the fiber material. In some embodiments, operations of the CNS-growth process can include removing sizing from a fiber material, applying an adhesion-inhibiting coating to the fiber material, applying a CNT-forming catalyst to the fiber, heating the fiber to CNT-synthesis temperature and performing CVD-promoted CNS growth on the catalyst-laden fiber material. Thus, where commercial fiber materials are employed, processes for constructing CNS-laden fibers can include a discrete step of removing sizing from the fiber material before disposing adhesion-inhibiting coating and the catalyst on the fiber material.

Synthesizing carbon nanotubes on the fiber material can include numerous techniques for forming carbon nanotubes, including those disclosed in co-pending U.S. Patent Application Publication No. 2004/0245088, which is incorporated herein by reference. The CNS grown on the fibers can be formed by techniques such as, for example, micro-cavity, thermal or plasma-enhanced CVD techniques, laser ablation, arc discharge, and high pressure carbon monoxide (HiPCO). In some embodiments, any conventional sizing agents can be removed prior CNT synthesis. In some embodiments, acetylene gas can be ionized to create a jet of cold carbon plasma for CNT synthesis. The plasma is directed toward the catalyst-bearing fiber material. Thus, in some embodiments for synthesizing CNS on a fiber material include (a) forming a carbon plasma; and (b) directing the carbon plasma onto the catalyst disposed on the fiber material. The diameters of the CNTs that are grown are dictated by the size of the CNT-forming catalyst as described above. In some embodiments, the sized fiber material is heated to between about 550° C. to about 800° C. to facilitate CNS synthesis. To initiate the growth of CNTs, two gases are bled into the reactor: a process gas such as argon, helium, or nitrogen, and a carbon-containing gas, such as acetylene, ethylene, ethanol or methane. CNTs grow at the sites of the CNT-forming catalyst.

In some embodiments, the CVD growth is plasma-enhanced. A plasma can be generated by providing an electric field during the growth process. CNTs grown under these conditions can follow the direction of the electric field. Thus, by adjusting the geometry of the reactor, vertically aligned carbon nanotubes can be grown radially about a cylindrical fiber. In some embodiments, a plasma is not required for radial growth about the fiber. For fiber materials that have distinct sides such as tapes, mats, fabrics, plies, and the like, catalyst can be disposed on one or both sides and correspondingly, CNTs can be grown on one or both sides as well.

As described above, CNS-synthesis can be performed at a rate sufficient to provide a continuous process for functionalizing spoolable fiber materials. Numerous apparatus configurations facilitate such continuous synthesis and result in the complex CNS morphology, as exemplified below.

One configuration for continuous CNS synthesis involves an optimally shaped (shaped to match the size and shape of the substrate) reactor for the synthesis and growth of carbon nanotubes directly on fiber materials. The reactor can be designed for use in a continuous in-line process for producing CNS-bearing fibers. In some embodiments, CNSs can be grown via a chemical vapor deposition (“CVD”) process at atmospheric pressure and at elevated temperature in the range of about 550° C. to about 800° C. in a multi-zone reactor. The fact that the synthesis occurs at atmospheric pressure is one factor that facilitates the incorporation of the reactor into a continuous processing line for CNS-on-fiber synthesis. Another advantage consistent with in-line continuous processing using such a zoned reactor is that CNT growth occurs in a seconds, as opposed to minutes (or longer) as in other procedures and apparatus configurations typical in the art.

CNS synthesis reactors in accordance with the various embodiments include the following features:

Optimally Shaped Synthesis Reactors: Adjusting the size of the growth chamber to more effectively match the size of the substrate traveling through it improves reaction rates as well as process efficiency by reducing the overall volume of the reaction vessel. The cross section of the optimally shaped growth chamber can be maintained below a volume ratio of chamber to substrate of 10,000. In some embodiments, the cross section of the chamber is maintained at a volume ratio of below 1,000. In other embodiments, the cross section of the chamber is maintained at a volume ratio below 500.

Although gas deposition processes, such as CVD, are typically governed by pressure and temperature alone, volume has a significant impact on the efficiency of deposition. By matching the shape of the substrate with the growth chamber there is greater opportunity for productive CNS forming reactions to occur. It should be appreciated that in some embodiments, the synthesis reactor has a cross section that is described by polygonal forms according the shape of the substrate upon which the CNS is grown to provide a reduction in reactor volume. In some embodiments, gas can be introduced at the center of the reactor or within a target growth zone, symmetrically, either through the sides or through the top and bottom plates of the reactor. This improves the overall CNT growth rate because the incoming feedstock gas is continuously replenishing at the hottest portion of the system, which is where CNT growth is most active. This constant gas replenishment is an important aspect to the increased growth rate exhibited by the shaped CNT reactors.

Zoning: Chambers that provide a relatively cool purge zone depend from both ends of the synthesis reactor. Applicants have determined that if hot gas were to mix with the external environment (i.e., outside of the reactor), there would be an increase in degradation of most fiber materials. The cool purge zones provide a buffer between the internal system and external environments. Typical CNT synthesis reactor configurations known in the art typically require that the substrate is carefully (and slowly) cooled. The cool purge zone at the exit of the present CNS growth reactor achieves the cooling in a short period of time, as required for the continuous in-line processing.

Non-contact, hot-walled, metallic reactor: In some embodiments, a hot-walled reactor made of metal can be employed, in particular stainless steel. This may appear counterintuitive because metal, and stainless steel in particular, is more susceptible to carbon deposition (i.e., soot and by-product formation). Thus, most CNT reactor configurations use quartz reactors because there is less carbon deposited, quartz is easier to clean, and quartz facilitates sample observation.

However, it has been observed that the increased soot and carbon deposition on stainless steel results in more consistent, faster, more efficient, and more stable CNT growth. Without being bound by theory it has been indicated that, in conjunction with atmospheric operation, the CVD process occurring in the reactor is diffusion limited. That is, the catalyst is “overfed;” too much carbon is available in the reactor system due to its relatively higher partial pressure (than if the reactor was operating under partial vacuum). As a consequence, in an open system—especially a clean one—too much carbon can adhere to catalyst particles, compromising their ability to synthesize CNTs. In some embodiments, the rectangular reactor is intentionally run when the reactor is “dirty,” that is with soot deposited on the metallic reactor walls. Once carbon deposits to a monolayer on the walls of the reactor, carbon will readily deposit over itself. Since some of the available carbon is “withdrawn” due to this mechanism, the remaining carbon feedstock, in the form of radicals, react with the catalyst at a rate that does not poison the catalyst. Existing systems run “cleanly” which, if they were open for continuous processing, would produce a much lower yield of CNTs at reduced growth rates.

Although it is generally beneficial to perform CNT synthesis “dirty” as described above, certain portions of the apparatus, such as gas manifolds and inlets, can nonetheless negatively impact the CNT growth process when soot created blockages. In order to combat this problem, such areas of the CNT growth reaction chamber can be protected with soot inhibiting coatings such as silica, alumina, or MgO. In practice, these portions of the apparatus can be dip-coated in these soot inhibiting coatings. Metals such as INVAR® can be used with these coatings as INVAR has a similar CTE (coefficient of thermal expansion) ensuring proper adhesion of the coating at higher temperatures, preventing the soot from significantly building up in critical zones.

In some embodiments, the reaction chamber may comprise SiC, alumina, or quartz as the primary chamber materials because they do not react with the reactive gases of CNS synthesis. This feature allows for increased efficiency and improves operability over long durations of operation.

Combined Catalyst Reduction and CNS Synthesis. In the CNT synthesis reactor, both catalyst reduction and CNS growth can occur within the reactor. This feature is significant because the reduction operation cannot be accomplished timely enough for use in a continuous process if performed as a discrete operation. In typical carbon nanotube synthesis processes, catalyst reduction typically takes 1-12 hours to perform. In synthesizing a carbon nanostructure according to the embodiments described herein, both catalyst reduction and CNS synthesis occur in the reactor, at least in part, due to the fact that carbon feedstock gas is introduced at the center of the reactor, not the end as would typically be performed using cylindrical reactors. The reduction process occurs as the fibers enter the heated zone; by this point, the gas has had time to react with the walls and cool off prior to reacting with the catalyst and causing the oxidation-reduction (via hydrogen radical interactions). It is this transition region where the reduction occurs. At the hottest isothermal zone in the system, the CNS growth occurs, with the greatest growth rate occurring proximal to the gas inlets near the center of the reactor.

In some embodiments, when loosely affiliated fiber materials, such as tow are employed, the continuous process can include operations that spreads out the strands and/or filaments of the tow. Thus, as a tow is unspooled it can be spread using a vacuum-based fiber spreading system, for example. When employing sized fibers, which can be relatively stiff, additional heating can be employed in order to “soften” the tow to facilitate fiber spreading. The spread fibers which comprise individual filaments can be spread apart sufficiently to expose an entire surface area of the filaments, thus allowing the tow to more efficiently react in subsequent process steps. Such spreading can approach between about 4 inches to about 6 inches across for a 3k tow. The spread tow can pass through a surface treatment step that is composed of a plasma system as described above. After a barrier coating is applied and roughened, spread fibers then can pass through a CNT-forming catalyst dip bath. The result is fibers of the tow that have catalyst particles distributed radially on their surface. The catalyzed-laden fibers of the tow then enter an appropriate CNT growth chamber, such as the optimally shaped chamber described above, where a flow through atmospheric pressure CVD or PE-CVD process is used to synthesize the CNS at rates as high as several microns per second. The fibers of the tow, now with radially aligned CNTs in the form of the CNS morphology, exit the CNT growth reactor.

In some embodiments, CNS-laden fiber materials can pass through yet another treatment process prior to isolation that, in some embodiments is a plasma process used to functionalize the CNS. Additional functionalization of CNS can be used to promote their adhesion to particular resins. Thus, in some embodiments, the processes can provide CNS-laden fiber materials having functionalized CNS. Completing this functionalization process while the CNS are still on the fiber can improve treatment uniformity.

In some embodiments, a continuous process for growing of CNS on spoolable fiber materials can achieve a linespeed between about 0.5 ft/min to about 36 ft/min. In this embodiment where the CNT growth chamber is 3 feet long and operating at a 750° C. growth temperature, the process can be run with a linespeed of about 6 ft/min to about 36 ft/min to produce, for example, CNTs having a length between about 1 micron to about 10 microns. The process can also be run with a linespeed of about 1 ft/min to about 6 ft/min to produce, for example, CNTs having a length between about 10 microns to about 100 microns. The process can be run with a linespeed of about 0.5 ft/min to about 1 ft/min to produce, for example, CNTs having a length between about 100 microns to about 200 microns. The CNT length is not tied only to linespeed and growth temperature, however, the flow rate of both the carbon feedstock and the inert carrier gases can also influence CNT length. For example, a flow rate consisting of less than 1% carbon feedstock in inert gas at high linespeeds (6 ft/min to 36 ft/min) will result in CNTs having a length between 1 micron to about 5 microns. A flow rate consisting of more than 1% carbon feedstock in inert gas at high linespeeds (6 ft/min to 36 ft/min) will result in CNTs having length between 5 microns to about 10 microns.

In some embodiments, more than one material can be run simultaneously through the process. For example, multiple tapes tows, filaments, strand and the like can be run through the process in parallel. Thus, any number of pre-fabricated spools of fiber material can be run in parallel through the process and re-spooled at the end of the process. The number of spooled fiber materials that can be run in parallel can include one, two, three, four, five, six, up to any number that can be accommodated by the width of the CNT-growth reaction chamber. Moreover, when multiple fiber materials are run through the process, the number of collection spools can be less than the number of spools at the start of the process. In such embodiments, strands, tows, or the like can be sent through a further process of combining such fiber materials into higher ordered fiber materials such as woven fabrics or the like. The continuous process can also incorporate a post processing chopper that facilitates the formation CNS-laden chopped fiber mats, for example.

The continuous processing can optionally include further CNS chemistry. Because the CNS is a polymeric network of CNTs, all the chemistries associated with individualized CNTs may be carried out on the CNS materials. Such chemistries can be performed inline with CNS preparation or separately. In some embodiments, the CNS can be modified while it is still substrate-bound. This can aid in purification of the CNS material. In other embodiments, the CNS chemistry can be performed after it is removed from the substrate upon which it was synthesized. Exemplary chemistries include those described herein above in addition to fluorination, oxidation, reduction, and the like. In some embodiments, the CNS material can be used to store hydrogen. In some embodiments, the CNS structure can be modified by attachment to another polymeric structure to form a diblock polymer. In some embodiments, the CNS structure can be used as a platform for attachment of a biomolecule. In some embodiments, the CNS structure can be configured to be used as a sensor. In some embodiments, the CNS structure can be incorporated in a matrix material to form a composite material. In some embodiments, a CNS structure can be modified with reagents known to unzip CNTs and form graphene nanoribbons. Numerous other chemistries and downstream applications can be recognized by those skilled in the art.

In some embodiments, the processes allow for synthesizing a first amount of a first type of CNS on the fiber material, in which the first type of CNS comprises CNTs selected to alter at least one first property of the fiber material. Subsequently, the processes allow for synthesizing a second amount of a second type of CNS on the fiber material, in which the second type of CNS contains carbon nanotubes selected to alter at least one second property of the fiber material.

In some embodiments, the first amount and second amount of CNTs are different. This can be accompanied by a change in the CNT type or not. Thus, varying the density of CNS can be used to alter the properties of the original fiber material, even if the CNT type remains unchanged. CNT type can include CNT length and the number of walls, for example. In some embodiments the first amount and the second amount are the same. If different properties are desirable along two different stretches of the fiber material, then the CNT type can be changed, such as the CNT length. For example, longer CNTs can be useful in electrical/thermal applications, while shorter CNTs can be useful in mechanical strengthening applications.

Electrical conductivity or specific conductance is a measure of a material's ability to conduct an electric current. CNTs with particular structural parameters such as the degree of twist, which relates to CNT chirality, can be highly conducting, thus exhibiting metallic properties. A recognized system of nomenclature for CNT chirality has been formalized and is recognized by those skilled in the art. Thus, for example, CNTs are distinguished from each other by a double index (n,m) where n and m are integers that describe the cut and wrapping of hexagonal graphite so that it makes a tube when it is wrapped onto the surface of a cylinder and the edges are sealed together. When the two indices are the same, m=n, the resultant tube is said to be of the “arm-chair” (or n,n) type, since when the tube is cut perpendicular to the CNT axis only the sides of the hexagons are exposed and their pattern around the periphery of the tube edge resembles the arm and seat of an arm chair repeated n times. Arm-chair CNTs, in particular SWNTs, are metallic, and have extremely high electrical and thermal conductivity. In addition, such SWNTs have extremely high tensile strength.

In addition to the degree of twist, CNT diameter also effects electrical conductivity. As described above, CNT diameter can be controlled by use of controlled size CNT-forming catalyst nanoparticles. CNTs can also be formed as semi-conducting materials. Conductivity in multi-walled CNTs (MWNTs) can be more complex. Interwall reactions within MWNTs can redistribute current over individual tubes non-uniformly. By contrast, there is no change in current across different parts of metallic single-walled nanotubes (SWNTs). Carbon nanotubes also have very high thermal conductivity, comparable to diamond crystal and in-plane graphite sheets. Any of these characteristic properties of CNTs can be exhibited in a CNS. In some embodiments, the CNS can facilitate realization of property enhancements in materials in which the CNS is incorporated to a degree that is greater than that of individualized CNTs.

Although the invention has been described with reference to the disclosed embodiments, those skilled in the art will readily appreciate that these are only illustrative of the invention. It should be understood that various modifications can be made without departing from the spirit of the invention. The invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

What is claimed is the following:

1. A separation membrane comprising:
a separation body having an effective pore size of about 1 micron or less and providing a tortuous path for passage of a substance therethrough, the separation body comprising carbon nanostructures;
wherein each carbon nanostructure comprises a plurality of carbon nanotubes that are branched, crosslinked, and share common walls with one another.

2. The separation membrane of claim 1, wherein at least a portion of the carbon nanotubes in each carbon nanostructure are aligned substantially parallel to one another.

3. The separation membrane of claim 1, wherein the carbon nanostructures are free of a growth substrate adhered to the carbon nanostructures.

4. The separation membrane of claim 3, wherein the carbon nanostructures are in the form of a carbon nanostructure flake material.

5. The separation membrane of claim 3, wherein the separation body comprises one or more layers of the carbon nanostructure flake material.

6. The separation membrane of claim 1, wherein at least a portion of the carbon nanostructures in the separation body are covalently bonded together.

7. The separation membrane of claim 1, wherein at least a portion of the carbon nanostructures in the separation body are functionalized.

8. The separation membrane of claim 1, wherein the separation body has at least an effective pore size ranging between about 1 micron and about 100 nm.

9. The separation membrane of claim 1, wherein the separation body has at least an effective pore size ranging between about 100 nm and about 10 nm.

10. The separation membrane of claim 1, wherein the separation body has at least an effective pore size ranging between about 10 nm and about 5 nm.

11. The separation membrane of claim 1, wherein the separation body has at least an effective pore size ranging between about 5 nm and about 1 nm.

12. The separation membrane of claim 1, wherein the separation body comprises a plurality of carbon nanostructure layers that are in direct contact with one another and configured in series with a progressively decreasing effective pore size in a direction of intended fluid flow.

13. The separation membrane of claim 12, wherein the separation body comprises a first carbon nanostructure layer having an effective pore size ranging between about 1 micron and about 100 nm, a second carbon nanostructure layer having an effective pore size ranging between about 100 nm and about 10 nm, and a third carbon nanostructure layer having an effective pore size ranging between about 10 nm and about 5 nm.

14. The separation membrane of claim 13, wherein the separation body further comprises a fourth carbon nanostructure layer having an effective pore size ranging between about 5 nm and about 1 nm.

15. The separation membrane of claim 1, further comprising:
an electrical connection configured to apply an electric current to at least a portion of the separation body.

16. The separation membrane of claim 1, wherein the separation body further comprises an additive within at least a portion of the carbon nanostructures, the additive being selected to establish the effective pore size within the carbon nanostructures.

17. The separation membrane of claim 16, wherein the additive is covalently bonded to the carbon nano structures.

18. The separation membrane of claim 1, wherein the carbon nanotubes in each carbon nanostructure are formed with branching, crosslinking, and sharing common walls with one another during formation of the carbon nanostructures on a growth substrate.

19. A separation system comprising:
at least one separation membrane comprising a separation body, the separation body having an effective pore size of about 1 micron or less and providing a tortuous path for passage of a substance therethrough, the separation body comprising carbon nanostructures;
wherein each carbon nanostructure comprises a plurality of carbon nanotubes that are branched, crosslinked, and share common walls with one another.

20. The separation system of claim 19, wherein at least a portion of the carbon nanotubes in each carbon nanostructure are aligned substantially parallel to one another.

21. The separation system of claim 19, wherein the at least one separation membrane comprises at least one separation body having an effective pore size ranging between about 1 micron and about 100 nm.

22. The separation system of claim 19, wherein the at least one separation membrane comprises at least one separation body having an effective pore size ranging between about 100 nm and about 10 nm.

23. The separation system of claim 19, wherein the at least one separation membrane comprises at least one separation body having an effective pore size ranging between about 10 nm and about 5 nm.

24. The separation system of claim 19, wherein the at least one separation membrane comprises at least one separation body having an effective pore size ranging between about 5 nm and about 1 nm.

25. The separation system of claim 19, wherein the separation body comprises a plurality of carbon nanostructure layers that are in direct contact with one another and configured in series with a progressively decreasing effective pore size in a direction of intended fluid flow.

26. The separation system of claim 25, wherein the separation body comprises a first carbon nanostructure layer having an effective pore size ranging between about 1 micron and about 100 nm, a second carbon nanostructure layer having an effective pore size ranging between about 100 nm and about 10 nm, and a third carbon nanostructure layer having an effective pore size ranging between about 10 nm and about 5 nm.

27. The separation system of claim 26, wherein the separation body further comprises a fourth carbon nanostructure layer having an effective pore size ranging between about 5 nm and about 1 nm.

28. The separation system of claim 19, wherein the at least one separation membrane comprises a plurality of carbon nanostructure layers that are spaced apart from one another and configured in series with a progressively decreasing effective pore size in a direction of intended fluid flow.

29. The separation system of claim 28, wherein the at least one separation membrane comprises:
a first separation membrane comprising a first carbon nanostructure layer having an effective pore size ranging between about 1 micron and about 100 nm;
a second separation membrane comprising a second carbon nanostructure layer having an effective pore size ranging between about 100 nm and about 10 nm; and
a third separation membrane comprising a third carbon nanostructure layer having an effective pore size ranging between about 10 nm and about 5 nm.

30. The separation system of claim 29, wherein the at least one separation membrane further comprises:
a fourth separation membrane comprising a fourth carbon nanostructure layer having an effective pore size ranging between about 5 nm and about 1 nm.

31. The separation system of claim 19, wherein the separation body further comprises an additive within at least a portion of the carbon nanostructures, the additive being selected to establish the effective pore size within the carbon nanostructures.

32. The separation system of claim 19, further comprising:
an electrical connection configured to apply an electric current to at least a portion of the separation body.

33. A method comprising:
providing at least one separation membrane comprising a separation body having an effective pore size of about 1 micron or less and providing a tortuous path for passage of a substance therethrough, the separation body comprising carbon nanostructures;
wherein each carbon nanostructure comprises a plurality of carbon nanotubes that are branched, crosslinked, and share common walls with one another;
passing a fluid phase containing particulate matter through the at least one separation membrane;
sequestering at least a portion of the particulate matter in at least a portion of the at least one separation membrane; and
eluting the fluid phase from the at least one separation membrane, the eluted fluid phase having a decreased quantity of particulate matter therein.

34. The method of claim 33, further comprising:
backflushing the at least one separation membrane to remove at least a portion of the particulate matter therefrom.

35. The method of claim 33, further comprising:
chemically treating the at least one separation membrane to remove at least a portion of the particulate matter therefrom.

36. The method of claim 33, further comprising:
applying an electric current to at least a portion of the at least one separation membrane to remove at least a portion of the particulate matter therefrom.

37. The method of claim 33, wherein the separation body comprises a plurality of carbon nanostructure layers that are in direct contact with one another and configured in series with a progressively decreasing effective pore size in a direction of intended fluid flow.

38. The method of claim 37, wherein the separation body comprises a first carbon nanostructure layer having an effective pore size ranging between about 1 micron and about 100 nm, a second carbon nanostructure layer having an effective pore size ranging between about 100 nm and about 10 nm, and a third carbon nanostructure layer having an effective pore size ranging between about 10 nm and about 5 nm.

39. The separation system of claim 38, wherein the separation body further comprises a fourth carbon nanostructure layer having an effective pore size ranging between about 5 nm and about 1 nm.
